(19) United States
(12) Patent Application Publication
(10) Pub. No.: US 2026/0347669 A1
(43) Pub. Date: Nov. 5, 2026

(54) COMPOSITE CONDUCTIVE ADHESIVE AND PREPARATION METHOD THEREOF, AND SECONDARY BATTERY

(71) Applicant: Ningde Amperex Technology Limited, Ningde (CN)

(72) Inventor: Xinlai ZHENG, Ningde (CN)

(73) Assignee: Ningde Amperex Technology Limited, Ningde (CN)

(21) Appl. No.: 19/663,342

(22) Filed: Apr. 30, 2026

(30) Foreign Application Priority Data
Apr. 30, 2025 (CN) 202510570064.3

(51) Int. Cl. C09J 9/02; C09J 11/04; C09J 11/08; C09J 175/04; H01M 4/02; H01M 4/62

(52) U.S. Cl. CPC C09J 9/02; C09J 11/04; C09J 11/08; C09J 175/04; H01M 4/625; C09J 2203/33; H01M 2004/027

(57) ABSTRACT

A composite conductive adhesive includes a polymer, carbon nanotubes, and a dispersant. The polymer is polyurethane. A length of a carbon nanotube in the composite conductive adhesive is L_{c} μm, and 5≤L_{c}≤20. A non-curvature ratio of the carbon nanotubes is

$$N = \frac{{N}_{1}}{{N}_{1} + {N}_{2}} ,$$

and N≥80%. When applied to a negative electrode material layer, the composite conductive adhesive of this application improves conductivity of the negative electrode material layer and imparts high adhesivity to the negative electrode material layer to mitigate expansion of a silicon-containing material, thereby improving cycling performance and cycling expansion performance of the secondary battery.

### CROSS-REFERENCE TO RELATED APPLICATION

This application claims priority to Chinese Patent Application No. 202510570064.3, filed on Apr. 30, 2025, the whole disclosure of which is incorporated herein by reference.

### TECHNICAL FIELD

This application relates to the field of electrochemical technology, and in particular, to a composite conductive adhesive and a preparation method thereof, and a secondary battery.

### BACKGROUND

Lithium-ion batteries possess advantages of a high energy density, a high operating voltage, and low environmental pollution, and have been widely used in various small portable devices such as mobile phones, digital cameras, laptop computers, and unmanned aerial vehicles, and have become a new type of green high-energy chemical power source with great development potential in the world today. Among various non-carbon negative electrode materials, a maximum theoretical gravimetric capacity of silicon negative electrode materials is up to 4200 mAh/g. Compared with currently commercialized graphite negative electrodes, the use of silicon negative electrodes can greatly increase the energy density of batteries. Therefore, silicon negative electrodes are regarded as a next-generation negative electrode material for lithium-ion batteries.

However, a negative electrode plate made of a silicon material exhibits relatively large expansion, which limits the application scenarios of the silicon negative electrodes. Moreover, due to the semiconductor properties of silicon, silicon electrode plates exhibit high powder resistivity and require a high-performance conductive network, thereby further limiting the performance of the silicon electrode plates. In the prior art, carbon nanotubes are added as a conductive agent to improve the conductivity of silicon negative electrodes. However, the aqueous carbon nanotube slurry used for silicon electrode plates requires extremely stringent process conditions to achieve superior dispersion properties, thereby limiting further performance enhancement, and hindering improvements in the cycling performance and cycling expansion performance of secondary batteries.

### SUMMARY

An objective of this application is to provide a composite conductive adhesive and a preparation method thereof, and a secondary battery, so as to improve the cycling performance and cycling expansion performance of the secondary battery. Specific technical solutions are as follows:

A first aspect of this application provides a composite conductive adhesive, including a polymer, carbon nanotubes, and a dispersant. The polymer is polyurethane. A length of a carbon nanotube in the composite conductive adhesive is L_{c} μm, satisfying: 5≤L_{c}≤20. A non-curvature ratio of the carbon nanotubes is

$$N = \frac{{N}_{1}}{{N}_{1} + {N}_{2}} ,$$

and N≥80%. In the formula, N₁ is a number of carbon nanotubes with θ₀ less than or equal to 5°, N₂ is a number of carbon nanotubes with θ₀ greater than 5°, and θ₀ is an angle between a straight line L₁ and a tangent line L₂. In a scanning electron microscope image of a film of the composite conductive adhesive, a straight line connecting two ends of the carbon nanotube is defined as the straight line L₁; an endpoint with a larger curvature of the carbon nanotube is defined as a head of the carbon nanotube, and a tangent line that is tangent to the carbon nanotube at the head is defined as the tangent line L₂. That the value of the length L_{c} of the carbon nanotubes in the composite conductive adhesive falls within the above range can improve the degree of dispersion of the carbon nanotubes and facilitate the formation of a conductive network. The fact that the value of the non-curvature ratio N of the carbon nanotubes falls within the above range indicates that the carbon nanotubes can be well dispersed in the film of the composite conductive adhesive of this application. A larger value of N indicates a higher degree of dispersion of the carbon nanotubes. In the composite conductive adhesive of this application, polyurethane assumes relatively low polarity, and can adhere well to the surface of the carbon nanotubes, making the carbon nanotubes easy to disperse. Applying the composite conductive adhesive to the negative electrode material layer improves the dispersion of the carbon nanotubes in the negative electrode material layer, facilitates the formation of a conductive network, and improves the conductivity of the negative electrode material layer. In addition, polyurethane is of high adhesiveness and elasticity, thereby not only endowing the negative electrode material layer with high adhesiveness, but also alleviating expansion of a silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

In some embodiments of this application, based on a mass of the composite conductive adhesive, a mass percentage of the polymer is 70% to 99.8%, a mass percentage of the carbon nanotubes is 0.1% to 12%, and a mass percentage of the dispersant is 0.1% to 18%. Controlling the mass percentage of the polymer, carbon nanotubes, and dispersant to fall within the above ranges makes it convenient for the polymer to uniformly adhere to the surface of the carbon nanotubes, and makes the carbon nanotubes easier to disperse. Applying the composite conductive adhesive of this application to the negative electrode material layer improves the dispersion of the carbon nanotubes in the negative electrode material layer, facilitates the formation of a conductive network, and improves the conductivity of the negative electrode material layer. In addition, this not only endows the negative electrode material layer with high adhesiveness, but also alleviates the problems of detachment and pulverization of the negative electrode material layer caused by insufficient adhesion during cycling of the secondary battery, thereby improving the cycling performance and cycling expansion performance of the secondary battery.

In some embodiments of this application, substances forming the polymer include an isocyanate monomer and a polyhydroxy polymer. The isocyanate monomer includes at least one of diphenylmethane diisocyanate, toluene diisocyanate, or isophorone diisocyanate. The polyhydroxy polymer includes at least one of polycarbonate diol, polypropylene carbonate diol, or polyethylene carbonate diol. The isocyanate monomer constitutes a first structural unit of the polymer. The polyhydroxy polymer constitutes a second structural unit of the polymer. Based on a sum of mole numbers of the first structural unit and the second structural unit, a mole percentage of the first structural unit is 45% to 55%, and a mole percentage of the second structural unit is 45% to 55%. The first structural unit can provide polar groups for the polymer. The second structural unit can provide non-polar groups and elasticity for the polymer. The polymer is polymerized from the isocyanate monomer and the polyhydroxy polymer falling within the above ranges. By controlling the mole percentage of the corresponding structural unit to fall within the range specified herein, this application endows the polymer with low polarity and high adhesiveness and elasticity, thereby making the carbon nanotubes easy to disperse in the composite conductive adhesive. This improves the conductivity and adhesiveness of the negative electrode material layer, and consequently further improves the cycling performance and cycling expansion performance of the secondary battery.

In some embodiments of this application, the composite conductive adhesive satisfies at least one of the following characteristics: (1) a pH value of a raw material of the polymer is 7 to 8.5; (2) in a raw material of the polymer, the polymer is emulsion particles, and an average particle diameter of the emulsion particles is 80 nm to 350 nm; (3) in a reduction curve of the polymer measured by cyclic voltammetry, a reduction peak appears at a voltage of 3 V to 0 V, a peak intensity of the reduction peak is Y₁, and a baseline intensity is Y₀, satisfying 1≤Y₁/Y₀≤1.01; (4) the polymer includes polar functional groups, the polar functional groups include a urethane group, an amino group, a hydroxyl group, and a cyano group, and a percentage of a total atomic mass of the polar functional groups relative to a weight-average molecular weight of the polymer is X, satisfying 10%≤X≤30%; (5) a swelling ratio of the polymer is 25% to 45%; or (6) 82%≤N≤98%. Satisfying at least one of the above characteristics can favorably improve the cycling performance and cycling expansion performance of the secondary battery.

In some embodiments of this application, the length of the carbon nanotube in a powder raw material of the carbon nanotubes is L_{c} μm, satisfying 0.05≤L_{c}/L₀≤0.5. The value of L/L₀ falling within the above range indicates that the length of the carbon nanotubes in the composite conductive adhesive is relatively large, and the length of the raw material of the carbon nanotubes is well retained, thereby facilitating the formation of a conductive network in the negative electrode material layer, improving the conductivity of the negative electrode material layer, and consequently improving the cycling performance of the secondary battery.

In some embodiments of this application, in a Raman spectrum of a raw material of the carbon nanotubes, a G peak appears at 1525 cm⁻¹ to 1625 cm⁻¹, a D peak appears at 1300 cm⁻¹ to 1400 cm⁻¹, an intensity of the G peak is I_{G}, and an intensity of the D peak is I_{D}, satisfying: I₀=I_{G}/I_{D}, and 60≤I₀≤80. The value of I₀ falling within the above range indicates that the raw material of the carbon nanotubes used in this application is little damaged and scarcely defective, thereby more favorably improving the conductivity of the negative electrode material layer, and consequently more effectively improving the cycling performance of the secondary battery.

In some embodiments of this application, in a Raman spectrum of the composite conductive adhesive, a G′ peak appears at 1525 cm⁻¹ to 1625 cm⁻¹, a D′ peak appears at 1300 cm⁻¹ to 1400 cm⁻¹, an intensity of the G′ peak is I_{G′}, and an intensity of the D′ peak is I_{D′}, satisfying: I₀=I_{G′}/I_{D′}, 1.03≤I₀/I₁≤1.5, and I₁≥50. That the values of I₀/I₁ and I₁ fall within the above ranges indicates that the carbon nanotubes in the composite conductive adhesive of this application are little damaged and scarcely defective, thereby more favorably improving the conductivity of the negative electrode material layer, and consequently more effectively improving the cycling performance of the secondary battery.

In some embodiments of this application, the dispersant includes at least one of polypropylene, cellulose, carboxymethyl cellulose, or lignin. The use of the dispersant falling within the above range allows the polymer to adhere more uniformly to the surface of the carbon nanotubes, and makes the carbon nanotubes easier to disperse. In this way, applying the composite conductive adhesive to the negative electrode material layer improves the dispersion of the carbon nanotubes in the negative electrode material layer, facilitates the formation of a conductive network, and improves the conductivity of the negative electrode material layer, thereby not only endowing the negative electrode material layer with high adhesiveness, but also alleviating expansion of a silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

In some embodiments of this application, the composite conductive adhesive satisfies at least one of the following characteristics: (1) when a mass percentage of the composite conductive adhesive in an aqueous dispersion of the composite conductive adhesive stirred at a temperature of 25 °C and a speed of 12 rpm is 8.0% to 10.0%, a viscosity of the aqueous dispersion of the composite conductive adhesive ranges from 1000 mPa·s to 5000 mPa·s; (2) a mass percentage of the composite conductive adhesive in an aqueous dispersion of the composite conductive adhesive is 8.0% to 10.0%, and a viscosity of the aqueous dispersion of the composite conductive adhesive is measured when the aqueous dispersion of the composite conductive adhesive is stored, an initial viscosity is η₀ mPa·s, the viscosity measured at a 7^{th} day is η₁ mPa·s, and the viscosity measured at a 28^{th} day is η₂ mPa·s, satisfying |η₁−η₀|≤500, and |η₂−η₀|≤800; (3) an elongation-at-break of the film of the composite conductive adhesive is 5% to 80%; or (4) tensile strength of the film of the composite conductive adhesive is 10 MPa to 45 MPa. Satisfying at least one of the above characteristics can favorably improve the cycling performance and cycling expansion performance of the secondary battery.

In some embodiments of this application, the composite conductive adhesive is dispersed in water to obtain a dilution with a solid content of 0.01 wt %. In a transmission electron microscope image at 100,000× magnification, the carbon nanotubes in the dilution are aggregated in the form of carbon nanotube bundles. The number of carbon nanotubes in each carbon nanotube bundle is 2 to 6. The polymer forms a film layer on a surface of each carbon nanotube. An average thickness of the film layers is 2 to 4 times a diameter of a single carbon nanotube. The diameter of the single carbon nanotube is 1.5 nm to 3.5 nm. When the above characteristics are satisfied, it indicates that, in the composite conductive adhesive of this application, the polymer (polyurethane) can adhere well to the surface of the carbon nanotubes, making the carbon nanotubes easy to disperse. Applying the composite conductive adhesive to the negative electrode material layer improves the dispersion of the carbon nanotubes in the negative electrode material layer, facilitates the formation of a conductive network, and improves the conductivity of the negative electrode material layer. In addition, polyurethane is of high adhesiveness and elasticity, thereby not only endowing the negative electrode material layer with high adhesiveness, but also alleviating expansion of a silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

A second aspect of this application provides a method for preparing the composite conductive adhesive provided in any one of the above embodiments. The method includes the following steps: performing a emulsification and shearing process and a homogenization process on the polymer, the carbon nanotubes, the dispersant, and water, where a rotational speed in the emulsification and shearing process is 6,000 rpm to 12,000 rpm; and in the homogenization process, a total number of homogenization passes is 7 to 12 and a homogenization pressure is 10 MPa to 20 MPa. Because the carbon nanotubes in the composite conductive adhesive of this application are highly dispersible, the number of homogenization passes required in the above preparation method is less than that required in conventional conductive adhesives. Therefore, the preparation method of the composite conductive adhesive of this application is simple and easy to implement.

A third aspect of this application provides a secondary battery. The secondary battery includes a positive electrode plate and a negative electrode plate. The negative electrode plate includes a negative current collector and a negative electrode material layer disposed on at least one surface of the negative current collector. The negative electrode material layer includes the composite conductive adhesive provided in any one of the above embodiments or a composite conductive adhesive prepared using the preparation method provided in any one of the above embodiments. The negative electrode material layer includes the above composite conductive adhesive, thereby not only facilitating the formation of a conductive network in the negative electrode material layer, and improving the conductivity of the negative electrode material layer, but also endowing the negative electrode material layer with high adhesiveness, and alleviating expansion of the silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

In some embodiments of this application, the negative electrode material layer further includes a silicon-containing material. The silicon-containing material includes at least one of silicon, a silicon-carbon compound, or a silicon-oxygen compound. Based on a mass of the negative electrode material layer, a mass percentage of silicon is M %, satisfying: 10≤M≤60. Selecting the silicon-containing material within the above range and controlling the mass percentage of silicon to fall within the above range endow the secondary battery with a relatively high energy density, and make it more convenient to exert the effect of the composite conductive adhesive in the silicon negative electrode system, thereby improving the cycling performance and cycling expansion performance of the secondary battery.

In some embodiments of this application, based on a mass of the negative electrode material layer, a mass percentage of the composite conductive adhesive is Q %, satisfying: 1.2≤Q≤11.5. By controlling the mass percentage of the composite conductive adhesive to fall within the above range, this application achieves high adhesion between particles of the negative active material, thereby not only facilitating the formation of a conductive network in the negative electrode material layer, improving the ion transmission capability of the negative electrode material layer, but also endowing the negative electrode material layer with high adhesiveness, and alleviating expansion of the silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

A fourth aspect of this application provides an electronic device. The electronic device includes the secondary battery provided in any one of the above embodiments. Therefore, the electronic device of this application exhibits a relatively long lifespan.

Some of the beneficial effects of this application are as follows:

This application provides a composite conductive adhesive and a preparation method thereof, and a secondary battery. The composite conductive adhesive includes a polymer, carbon nanotubes, and a dispersant. The polymer is polyurethane. The length of a carbon nanotube in the composite conductive adhesive is L_{c} μm, satisfying: 5≤L_{c}≤20. The non-curvature ratio of the carbon nanotubes is

$$N = \frac{{N}_{1}}{{N}_{1} + {N}_{2}} ,$$

and N≥80%. That the value of the length L_{c} of the carbon nanotubes in the composite conductive adhesive falls within the above range can improve the dispersion of the carbon nanotubes and facilitate the formation of a conductive network. In addition, the fact that the value of the non-curvature ratio N of the carbon nanotubes falls within the above range indicates that the carbon nanotubes can be well dispersed in the film of the composite conductive adhesive of this application. In the composite conductive adhesive of this application, polyurethane assumes relatively low polarity, and can adhere well to the surface of the carbon nanotubes, making the carbon nanotubes easy to disperse. Applying the composite conductive adhesive to the negative electrode material layer improves the dispersion of the carbon nanotubes in the negative electrode material layer, facilitates the formation of a conductive network, and improves the conductivity of the negative electrode material layer. In addition, polyurethane is of high adhesiveness and elasticity, thereby not only endowing the negative electrode material layer with high adhesiveness, but also alleviating expansion of a silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application more clearly, the following outlines the drawings to be used in the description of the embodiments. Evidently, the drawings outlined below merely illustrate some embodiments of this application, and a person of ordinary skill in the art may derive other embodiments based on the drawings.

FIG. 1 is a schematic diagram of a method for statistically determining a non-curvature ratio of carbon nanotubes;

FIG. 2 is a scanning electron microscope image of a film prepared from a composite conductive adhesive according to Embodiment 1-1;

FIG. 3 is a scanning electron microscope image of a film prepared from a composite conductive adhesive according to Comparative Embodiment 1-1; and

FIG. 4 is a transmission electron microscope image of a composite conductive adhesive according to Embodiment 1-1.

### DETAILED DESCRIPTION

The following describes the technical solutions in this application clearly and comprehensively with reference to the embodiments and accompanying drawings hereof. Evidently, the described embodiments are merely a part of but not all of the embodiments of this application. All other embodiments derived by a person skilled in the art based on this application still fall within the protection scope of this application.

It is noted that in specific embodiments of this application, this application is construed by using a lithium-ion battery as an example of the electrochemical device, but the electrochemical device according to this application is not limited to the lithium-ion battery.

A first aspect of this application provides a composite conductive adhesive. The composite conductive adhesive includes a polymer, carbon nanotubes, and a dispersant. The polymer is polyurethane. A length of a carbon nanotube in the composite conductive adhesive is L_{c} μm, satisfying: 5≤L_{c}≤20. For example, the value of L_{c} may be 5, 7, 9, 10, 13, 15, 18, 20, or a value falling within a range formed by any two thereof. A non-curvature ratio of the carbon nanotubes is

$$N = \frac{{N}_{1}}{{N}_{1} + {N}_{2}} ,$$

and N≥80%, and preferably 82%≤N≤98%. For example, the value of N may be 80%, 82%, 85%, 88%, 90%, 95%, 98%, 99%, or a value falling within a range formed by any two thereof. In the formula, N₁ is the number of carbon nanotubes with θ₀ less than or equal to 5°, N₂ is the number of carbon nanotubes with θ₀ greater than 5°, and θ₀ is an angle between a straight line L₁ and a tangent line L₂. In a scanning electron microscope image of a film of the composite conductive adhesive, a straight line connecting two ends of the carbon nanotube is defined as the straight line L₁; an endpoint with a larger curvature of the carbon nanotube is defined as a head of the carbon nanotube, and a tangent line that is tangent to the nanotube at the head is defined as the tangent line L₂.

The applicant hereof finds that when the value of L_{c} is excessively small, for example, less than 5, the length of the carbon nanotubes in the composite conductive adhesive is excessively short, thereby being unfavorable to the formation of a composite conductive network in the negative electrode material layer when applied to the negative electrode material layer. When the value of L_{c} is excessively large, for example, greater than 20, the length of the carbon nanotubes in the composite conductive adhesive is excessively long, making the nanotubes difficult to disperse and resulting in a high degree of curling and agglomeration. Therefore, that the value of the length L_{c} of the carbon nanotubes in the composite conductive adhesive fall within the above range can improve the dispersion of the carbon nanotubes and facilitate the formation of a conductive network. The fact that the value of the non-curvature ratio N of the carbon nanotubes falls within the above range indicates that the carbon nanotubes can be well dispersed in the film of the composite conductive adhesive of this application. A larger value of N leads to a higher degree of dispersion of the carbon nanotubes, and a smaller value of N leads to a lower degree of dispersion of the carbon nanotubes. In the composite conductive adhesive of this application, polyurethane exists on at least a part of the surface of the carbon nanotubes. The polyurethane assumes relatively low polarity, and can adhere well to the surface of the carbon nanotubes, making the carbon nanotubes easy to disperse. Applying the composite conductive adhesive to the negative electrode material layer improves the dispersion of the carbon nanotubes in the negative electrode material layer, facilitates the formation of a conductive network, and improves the conductivity of the negative electrode material layer. In addition, polyurethane is of high adhesiveness and elasticity, thereby not only endowing the negative electrode material layer with high adhesiveness, but also alleviating expansion of a silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

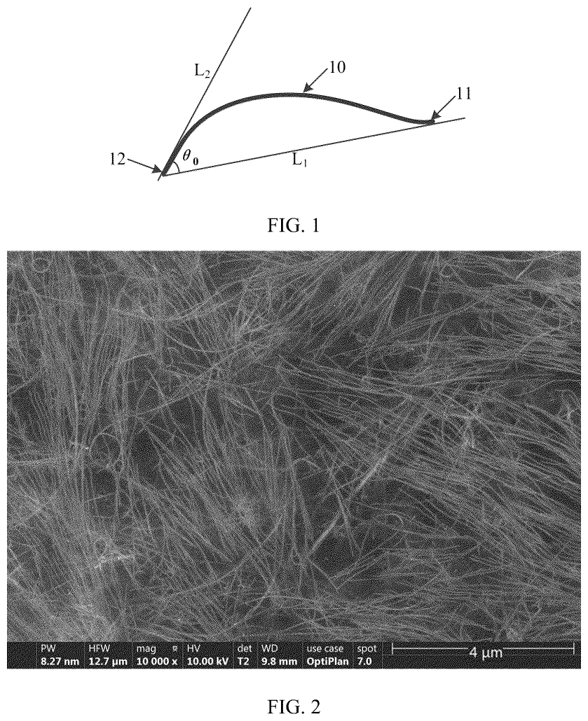

The composite conductive adhesive is made into a film. The non-curvature ratio of the carbon nanotubes is statistically determined from a scanning electron microscope image of the composite conductive adhesive, where N₁ and N₂ are determined by the following method: connecting the two ends of a carbon nanotube to form a straight line L₁; selecting an endpoint with a larger curvature of the carbon nanotube as a head of the carbon nanotube, and drawing a tangent line L₂ that is tangent to the carbon nanotube at the head; denoting an angle between the straight line L₁ and the tangent line L₂ as θ₀; and recording the number of carbon nanotubes with θ₀ less than or equal to 5° as N₁, and recording the number of carbon nanotubes with θ₀ greater than 5° as N₂, satisfying: 0≤θ₀≤180°. In some embodiments, (N₁+N₂)≥100. As shown in FIG. 1, a carbon nanotube 10 includes a first endpoint 11 and a second endpoint 12. The first endpoint 11 and the second endpoint 12 are connected to form a straight line L₁. The curvature at the first endpoint 11 is less than the curvature at the second endpoint 12, and therefore, the second endpoint 12 is used as a head of the carbon nanotube, and a tangent line L₂ is drawn at the head. The angle between the straight line L₁ and the tangent line L₂ is 00.

In some embodiments of this application, based on a mass of the composite conductive adhesive, a mass percentage of the polymer is 70% to 99.8%, a mass percentage of the carbon nanotubes is 0.1% to 12%, and a mass percentage of the dispersant is 0.1% to 18%. For example, the mass percentage of the polymer may be 70%, 75%, 80%, 85%, 87.5%, 90%, 95%, 97.5%, 98%, 99.8%, or a value falling within a range formed by any two thereof, the mass percentage of the carbon nanotubes may be 0.1%, 0.5%, 1%, 2%, 2.5%, 3.5%, 5%, 8%, 10%, 12%, or a value falling within a range formed by any two thereof, and the mass percentage of the dispersant may be 0.1%, 1%, 3%, 6%, 8%, 10%, 12%, 14%, 16%, 18%, or a value falling within a range formed by any two thereof. Controlling the mass percentage of the polymer, carbon nanotubes, and dispersant to fall within the above ranges makes it convenient for the polymer to uniformly adhere to the surface of the carbon nanotubes, and makes the carbon nanotubes easier to disperse. Applying the composite conductive adhesive of this application to the negative electrode material layer improves the dispersion of the carbon nanotubes in the negative electrode material layer, facilitates the formation of a conductive network, and improves the conductivity of the negative electrode material layer. In addition, this not only endows the negative electrode material layer with high adhesiveness, but also alleviates the problems of detachment and pulverization of the negative electrode material layer caused by insufficient adhesion during cycling of the secondary battery, thereby improving the cycling performance and cycling expansion performance of the secondary battery.

In some embodiments of this application, substances forming the polymer include an isocyanate monomer and a polyhydroxy polymer. The isocyanate monomer includes at least one of diphenylmethane diisocyanate, toluene diisocyanate, or isophorone diisocyanate (IPDI). The polyhydroxy polymer includes at least one of polycarbonate diol (PCDL), polypropylene carbonate diol, or polyethylene carbonate diol. The isocyanate monomer constitutes a first structural unit of the polymer. The polyhydroxy polymer constitutes a second structural unit of the polymer. Based on a sum of mole numbers of the first structural unit and the second structural unit, a mole percentage of the first structural unit is 45% to 55%, and a mole percentage of the second structural unit is 45% to 55%. For example, the mole percentage of the first structural unit may be 45%, 48%, 50%, 51%, 52%, 53%, 54%, 55%, or a value falling within a range formed by any two thereof, and the mole percentage of the second structural unit may be 45%, 48%, 50%, 51%, 52%, 53%, 54%, 55%, or a value falling within a range formed by any two thereof. The isocyanate monomer and the polyhydroxy polymer are polymerized through a polycondensation reaction to obtain a polymer, namely, polyurethane. The isocyanate monomer constitutes the first structural unit of the polyurethane, and the polyhydroxy polymer constitutes the second structural unit of the polyurethane. The first structural unit can provide polar groups for the polymer, thereby endowing the polymer with superior adhesiveness and dispersibility. Meanwhile, the first structural unit serves as a crosslinking point, thereby restricting the movement of the second structural unit that serves as a soft segment. The second structural unit provides a non-polar structure for the polymer to enhance the affinity of the polymer for the carbon nanotubes, and can also endow the polymer with elasticity, thereby enabling the polymer to be well flexible and fatigue-resistant. The polymer is polymerized from the isocyanate monomer and the polyhydroxy polymer falling within the above ranges. By controlling the mole percentage of the corresponding structural units to fall within the range specified herein, this application endows the polymer with low polarity and high adhesiveness and elasticity. In addition, different types of isocyanate monomers and polyhydroxy polymers are selected to adjust the polarity and mechanical properties of the polymer, thereby making the carbon nanotubes easy to disperse in the composite conductive adhesive. This also improves the conductivity and adhesiveness of the negative electrode material layer, and further improves the cycling performance and cycling expansion performance of the secondary battery.

In some embodiments of this application, the pH value of the raw material of the polymer is between 7 and 8.5. For example, the pH value of the raw material of the polymer may be 7, 7.2, 7.5, 7.8, 8, 8.3, 8.5, or a value falling within a range formed by any two thereof. Controlling the pH value of the raw material of the polymer to fall within the above range allows the polymer chain segments to be more extended, resulting in a stronger steric hindrance effect on the carbon nanotubes. Further, after being deprotonated, the polar functional groups in the polymer exert an electrostatic repulsion effect on the surface of the carbon nanotubes, thereby improving the stability of the polymer itself and the aqueous dispersion of the composite conductive adhesive. This reduces the risk of gas generation during slurry preparation when the composite conductive adhesive is applied to the negative electrode material layer, and improves the processability of the negative electrode slurry, thereby more effectively exerting the function of the composite conductive adhesive in the negative electrode material layer, improving the conductivity and adhesiveness of the negative electrode material layer, and consequently improving the cycling performance and cycling expansion performance of the secondary battery.

In some embodiments of this application, in a raw material of the polymer, the polymer is emulsion particles, and an average particle diameter of the emulsion particles is 80 nm to 350 nm. For example, the average particle diameter of the emulsion particles may be 80 nm, 100 nm, 150 nm, 180 nm, 200 nm, 230 nm, 250 nm, 300 nm, 350 nm, or a value falling within a range formed by any two thereof. Controlling the average particle diameter of the emulsion particles in the raw material of the polymer to fall within the above range makes it more convenient for the polymer to more uniformly adhere to the surface of the carbon nanotubes, and makes the carbon nanotubes in the composite conductive adhesive easier to disperse, thereby exerting the function of the composite conductive adhesive in the negative electrode material layer, improving the conductivity and adhesiveness of the negative electrode material layer, and improving the cycling performance and cycling expansion performance of the secondary battery.

In some embodiments of this application, in a reduction curve of the polymer measured by cyclic voltammetry, a reduction peak appears at a voltage of 3 V to 0 V, the peak intensity of the reduction peak is Y₁, and the baseline intensity is Y₀, satisfying: 1≤Y₁/Y₀≤1.01. When Y₁/Y₀=1, it indicates that there is no reduction peak in the reduction curve of the polymer of this application. When 1<Y₁/Y₀≤1.01, it indicates that the intensity of the reduction peak in the reduction curve of the polymer of this application is very low. When the above characteristics are satisfied, it indicates that the polymer is of high electrochemical stability. The composite conductive adhesive contains the polymer that assumes such characteristics, thereby more effectively exerting the function of the composite conductive adhesive and further improving the cycling performance and cycling expansion performance of the secondary battery.

In some embodiments of this application, the polymer includes polar functional groups. The polar functional groups include a urethane group, an amino group, a hydroxyl group, and a cyano group. A percentage of a total atomic mass of the polar functional groups relative to a weight-average molecular weight of the polymer is X, satisfying 10%≤X≤30%. For example, the value of X may be 10%, 12%, 15%, 20%, 22%, 25%, 28%, 30%, or a value falling within a range formed by any two thereof. The polymer includes polar functional groups, and the value of X is controlled to fall within the above range, thereby endowing the polymer with low polarity and high adhesiveness and elasticity, and making the carbon nanotubes easy to disperse in the composite conductive adhesive. This improves the conductivity and adhesiveness of the negative electrode material layer, and consequently further improves the cycling performance and cycling expansion performance of the secondary battery.

In some embodiments of this application, the swelling ratio of the polymer is 25% to 45%. For example, the swelling ratio of the polymer may be 25%, 28%, 30%, 33%, 35%, 38%, 40%, 43%, 45%, or a value falling within a range formed by any two thereof. Controlling the swelling ratio of the polymer to fall within the above range makes the polymer highly tolerant of an electrolyte solution, makes the polymer highly stable during cycling of the secondary battery, and reduces the risk of dissolution of the polymer, thereby improving the cycling performance and cycling expansion performance of the secondary battery.

In some embodiments, the elongation-at-break of the polymer film is 250% to 400%. For example, the elongation-at-break of the polymer film may be 250%, 280%, 300%, 320%, 350%, 380%, 390%, ⁴⁰⁰%, or a value falling within a range formed by any two thereof. In some embodiments, the tensile strength of the polymer film is 0.5 MPa and 5 MPa. For example, the tensile strength of the polymer film may be 0.5 MPa, 1 MPa, 3 MPa, 4 MPa, 5 MPa, or a value falling within a range formed by any two thereof. When the elongation-at-break and the tensile strength of the polymer film are controlled to fall within the above ranges, it indicates that the polymer film is of superior toughness and tensile properties, thereby enabling the composite conductive adhesive to be more adaptable to the expansion of the silicon-containing material during cycling of the secondary battery, alleviating the problems of detachment and pulverization of the negative electrode material layer caused by silicon expansion during cycling of the secondary battery, and consequently improving the cycling performance and cycling expansion performance of the secondary battery.

In some embodiments, the length of the carbon nanotube in the powder raw material of the carbon nanotubes is L_{c} μm, satisfying: 40≤L₀≤120. For example, the length of the carbon nanotube may be 40 μm, 50 μm, 60 μm, 70 μm, 80 μm, 90 μm, 100 μm, 110 μm, 120 μm, or a value falling within a range formed by any two thereof. When the value of L₀ falls within the above range, it indicates that the length of the carbon nanotube in the powder raw material of the carbon nanotubes is relatively large.

In some embodiments of this application, 0.05≤L_{c}/L₀≤0.5. For example, the value of L_{c}/L_{c} may be 0.05, 0.10, 0.15, 0.2, 0.25, 0.3, 0.35, 0.4, 0.45, 0.5, or a value falling within a range formed by any two thereof. The value of L_{c}/L₀ falling within the above range indicates that the length of the carbon nanotubes in the composite conductive adhesive is relatively large, and the length of the raw material of the carbon nanotubes is well retained, thereby facilitating the formation of a conductive network in the negative electrode material layer, improving the conductivity of the negative electrode material layer, and consequently improving the cycling performance of the secondary battery.

In some embodiments of this application, in a Raman spectrum of the raw material of the carbon nanotubes, a G peak appears at 1525 cm⁻¹ to 1625 cm⁻¹, a D peak appears at 1300 cm⁻¹ to 1400 cm⁻¹, the intensity of the G peak is I_{G}, and the intensity of the D peak is I_{D}, satisfying: I₀=I_{G}/I_{D}, and 60≤I₀≤80. For example, the value of I₀ may be 60, 63, 65, 68, 70, 73, 75, 78, 80, or a value falling within a range formed by any two thereof. The value of I₀ falling within the above range indicates that the raw material of the carbon nanotubes used in this application is little damaged and scarcely defective, thereby more favorably improving the conductivity of the negative electrode material layer, and consequently more effectively improving the cycling performance of the secondary battery.

In some embodiments of this application, in a Raman spectrum of the composite conductive adhesive, a G′ peak appears at 1525 cm⁻¹ to 1625 cm⁻¹, a D′ peak appears at 1300 cm⁻¹ to 1400 cm⁻¹, the intensity of the G′ peak is I_{G′}, and the intensity of the D′ peak is I_{D′}, satisfying: I₁=I_{G}/I_{D′}, 1.03≤I₀/I₁≤1.5, and I₁≥50. In some embodiments, 80≥I₁≥50. For example, the value of I₀/I₁ may be 1.03, 1.1, 1.2, 1.3, 1.4, 1.5, or a value falling within a range formed by any two thereof, and the value of I₁ may be 50, 55, 58, 60, 65, 70, 75, 80, or a value falling within a range formed by any two thereof. That the values of I₀/I₁ and I₁ fall within the above ranges indicates that the carbon nanotubes in the composite conductive adhesive of this application are little damaged and scarcely defective, thereby more favorably improving the conductivity of the negative electrode material layer, and consequently more effectively improving the cycling performance of the secondary battery.

In some embodiments of this application, the dispersant includes at least one of polypropylene, cellulose, carboxymethyl cellulose, or lignin. The use of the dispersant falling within the above range allows the polymer to adhere more uniformly to the surface of the carbon nanotubes, and makes the carbon nanotubes easier to disperse. In this way, applying the composite conductive adhesive to the negative electrode material layer improves the dispersion of the carbon nanotubes in the negative electrode material layer, facilitates the formation of a conductive network, and improves the conductivity of the negative electrode material layer. In addition, polyurethane is of high adhesiveness and elasticity, thereby not only endowing the negative electrode material layer with high adhesiveness, but also alleviating expansion of a silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

The weight-average molecular weight (Mw) and the molecular weight distribution (PDI) of the dispersant are not particularly limited herein, as long as the objectives of this application can be achieved. For example, Mw may be 10,000 to 100,000, and the PDI may be 1 to 1.5.

In this application, the raw material of the polymer may be synthesized using a prepolymer dispersion method. For example, the prepolymer dispersion method may include but is not limited to: dehydrating a polyhydroxy polymer at a temperature of 90 °C to 110 °C at a vacuum pressure lower than 5 mm Hg for 1 to 3 hours to make the moisture content lower than 0.03%; adding an isocyanate monomer, and reacting the mixture at 70 °C to 90 °C for 2 to 4 hours; and then adding acetone (to reduce viscosity), and adjusting the solid content to 40 wt % to 60 wt %; adding triethylamine (TEA) as a neutralizing agent; and slowly adding deionized water while stirring at a speed of 1500 rpm to 2500 rpm to form an oil-in-water emulsion. Performing a polymerization reaction at a temperature of 40 °C to 60 °C for 0.5 to 1.5 hours. Performing vacuum distillation at 30 °C to 50 °C to remove the acetone and obtain a polymer emulsion with a solid content of 30 wt % to 40 wt %, that is, the raw material of the polymer. Optionally, a chain extender may be added first before the polymerization reaction is performed. The chain extender in this application may include, but is not limited to, at least one of 1,4-butanediol, 1,6-hexanediol, or ethylenediamine. The amount of the chain extender and the amount of the neutralizing agent are not particularly limited herein. Those skilled in the art may design the amounts according to actual needs, as long as the objectives of this application can be achieved.

Under normal circumstances, the percentage X of the total atomic mass of the polar functional groups relative to the weight-average molecular weight of the polymer may be controlled by adjusting the polymerization reaction time or the amount of the chain extender. With other factors remaining constant, decreasing the amount of the chain extender increases X, and increasing the amount of the chain extender decreases X. Shortening the polymerization time increases X, and increasing the polymerization time decreases X. Generally, the pH of the raw material of the polymer may be adjusted by changing the amount of the neutralizing agent. With other factors remaining constant, increasing the amount of the neutralizing agent increases the pH value, and reducing the amount of the neutralizing agent decreases X.

Generally, the average particle diameter of the raw material of the polymer may be changed by adjusting the polymerization reaction time and temperature. With other factors remaining constant, increasing the polymerization reaction time increases the average particle diameter of the raw material of the polymer, and reducing the polymerization reaction time decreases the average particle diameter of the raw material of the polymer. Increasing the polymerization reaction temperature increases the average particle diameter of the raw material of the polymer, and reducing the polymerization reaction temperature decreases the average particle diameter of the raw material of the polymer.

In this application, the raw material of the carbon nanotubes may be synthesized by a vapor deposition method. The preparation process of the raw material of the carbon nanotubes is not particularly limited herein, as long as the objectives of this application can be achieved. The carbon nanotubes are not particularly limited herein, as long as the objectives of this application can be achieved. For example, a carbon nanotube may be at least one of a single-walled carbon nanotube, a multi-walled carbon nanotube, or a few-walled carbon nanotube.

In this application, the raw material of the polymer, the raw material of the carbon nanotubes, and the dispersant may be commercially available conventional substances, and the sources thereof are not particularly limited, as long as the objectives of this application can be achieved. The substances that fall within the ranges specified herein may be selected using the test method described herein or using the corresponding test methods described in the equipment manual.

In this application, the raw material of the polymer means the polymer emulsion obtained by purchase or synthesis, and the raw material of the carbon nanotubes means the carbon nanotubes obtained by purchase or synthesis without undergoing an emulsification and shearing process and a homogenization process.

In some embodiments of this application, when the mass percentage of the composite conductive adhesive in an aqueous dispersion of the composite conductive adhesive stirred at a temperature of 25 °C and a speed of 12 rpm is 8.0% to 10.0%, the viscosity of the aqueous dispersion of the composite conductive adhesive ranges from 1000 mPa·s to 5000 mPa·s. For example, the viscosity of the aqueous dispersion of the composite conductive adhesive may be 1000 mPa·s, 1500 mPa·s, 2000 mPa·s, 2500 mPa·s, 3000 mPa·s, 3500 mPa·s, 4000 mPa·s, 5000 mPa·s, or a value falling within a range formed by any two thereof. Controlling the viscosity of the aqueous dispersion of the composite conductive adhesive to fall within the above range makes the composite conductive adhesive highly dispersible and stable in the aqueous dispersion thereof. In this way, when applied to a negative electrode material layer, the composite conductive adhesive facilitates the formation of a conductive network in the negative electrode material layer, and can also alleviate the expansion of the silicon-containing material, thereby improving the cycling performance and cycling expansion performance of the secondary battery.

In some embodiments of this application, the mass percentage of the composite conductive adhesive in an aqueous dispersion of the composite conductive adhesive is 8.0% to 10.0%, and a viscosity of the aqueous dispersion of the composite conductive adhesive is measured when the aqueous dispersion of the composite conductive adhesive is stored, an initial viscosity is η₀ mPa·s, the viscosity measured at a 7^{th} day is η₁ mPa·s, and the viscosity measured at a 28^{th} day is η₂ mPa·s, satisfying |η₁−η₀|≤500, and |η₂−η₀|≤800. For example, |η₁−η₀| may be 0, 5, 50, 100, 200, 300, 400, 500, or a value falling within a range formed by any two thereof |η₂−η₀| may be 0, 5, 50, 100, 200, 300, 400, 500, 600, 800, or a value falling within a range formed by any two thereof. When the above characteristics are satisfied, it indicates that the aqueous dispersion of the composite conductive adhesive is of high stability during storage. Therefore, when applied to a negative electrode material layer, the composite conductive adhesive facilitates the formation of a uniformly dispersed conductive network in the negative electrode material layer, thereby further improving the cycling performance and cycling expansion performance of the secondary battery.

In some embodiments of this application, the elongation-at-break of the film of the composite conductive adhesive is 5% to 80%, and/or the tensile strength of the film of the composite conductive adhesive is 10 MPa to 45 MPa. For example, the elongation-at-break of the film of the composite conductive adhesive may be 5%, 12%, 20%, 30%, 40%, 50%, 60%, 75%, 80%, or a value falling within a range formed by any two thereof, and the tensile strength of the film of the composite conductive adhesive may be 10 MPa, 15 MPa, 20 MPa, 25 MPa, 30 MPa, 35 MPa, 40 MPa, 45 MPa, or a value falling within a range formed by any two thereof. When the elongation-at-break and/or the tensile strength of the film of the composite conductive adhesive is controlled to fall within the above ranges, it indicates that the film of the composite conductive adhesive is of superior toughness and tensile properties, thereby alleviating the expansion of the silicon-containing material during cycling of the secondary battery, alleviating the problems of detachment and pulverization of the negative electrode material layer caused by the expansion of the silicon-containing material during cycling of the secondary battery, and consequently improving the cycling performance and cycling expansion performance of the secondary battery.

In some embodiments of this application, the composite conductive adhesive is dispersed in water to obtain a dilution with a solid content of 0.01 wt %. In a transmission electron microscope image at 100,000× magnification, the carbon nanotubes in the dilution are aggregated in the form of carbon nanotube bundles. The number of carbon nanotubes in each carbon nanotube bundle is 2 to 6. The polymer forms a film layer on a surface of each carbon nanotube. An average thickness of the film layers is 2 to 4 times a diameter of a single carbon nanotube. The diameter of the single carbon nanotube is 1.5 nm to 3.5 nm. For example, the number of carbon nanotubes in the carbon nanotube bundle may be 2, 3, 4, 5, 6, or a value falling within a range formed by any two thereof. For example, the average thickness of the film layer is a multiple of the diameter of a single carbon nanotube, and the multiple may be 2, 2.5, 3, 3.5, 4, or a value falling within a range formed by any two thereof. The diameter of a single carbon nanotube may be 1.5 nm, 1.6 nm, 1.8 nm, 2 nm, 2.5 nm, 2.8 nm, 3 nm, 3.5 nm, or a value falling within a range formed by any two thereof. The average thickness of the film layer may be 3 nm to 14 nm. For example, the average thickness of the film layer may be 3 nm, 5 nm, 6 nm, 8 nm, 10 nm, 12 nm, 14 nm, or a value falling within a range formed by any two thereof. When the above characteristics are satisfied, it indicates that, in the composite conductive adhesive of this application, the polymer (polyurethane) can adhere well to the surface of the carbon nanotubes, and the carbon nanotubes in the composite conductive adhesive is highly dispersible. Therefore, when applied to a negative electrode material layer, the composite conductive adhesive facilitates the formation of a uniformly dispersed conductive network in the negative electrode material layer, thereby further improving the cycling performance and cycling expansion performance of the secondary battery.

A second aspect of this application provides a method for preparing the composite conductive adhesive provided in any one of the above embodiments. The method includes the following steps: performing a emulsification and shearing process and a homogenization process on the polymer, the carbon nanotubes, the dispersant, and water, where a rotational speed in the emulsification and shearing process is 6,000 rpm to 12,000 rpm. For example, the rotational speed in the emulsification and shearing process may be 6,000 rpm, 7,000 rpm, 8,000 rpm, 9,000 rpm, 10,000 rpm, 11,000 rpm, 12,000 rpm, or a value falling within a range formed by any two thereof. The homogenization process includes a plurality of homogenization passes. A total number of homogenization passes is 7 to 12, and the homogenization pressure is 10 MPa to 20 MPa. For example, the total number of homogenization passes may be 7, 8, 9, 10, 11, 12, or a value falling within a range formed by any two thereof, and the homogenization pressure may be 10 MPa, 12 MPa, 15 MPa, 16 MPa, 18 MPa, 20 MPa, or a value falling within a range formed by any two thereof. Because the carbon nanotubes in the composite conductive adhesive of this application are highly dispersible, the number of homogenization passes required in the above preparation method is less than that required in conventional conductive adhesives. Therefore, the preparation method of the composite conductive adhesive of this application is simple and easy to implement.

In this application, the emulsification and shearing process and the homogenization process may include, but are not limited to, the following steps:

(1) Adding 0.1 to 7.5 parts of dispersant and 900 to 1,000 parts of deionized water solvent into an emulsifier for dispersion. Setting a dispersion speed to 9,000 rpm to 12,000 rpm and setting the dispersion time to 10 min to 20 min. Subsequently, adding a total of 0.1 to 5 parts of carbon nanotube raw material in N portions, with no more than 0.5 part added each time. Emulsifying the carbon nanotube raw material after each addition, where each emulsification process is performed for 5 to 15 min at a speed of 9,000 to 12,000 rpm, so as to obtain a first emulsified mixture after completion of emulsification, where, 1≤N≤10.

(2) Adding the first emulsified mixture into a homogenizer for undergoing a first homogenization process, so as to obtain a material subjected to the first homogenization process. In the first homogenization process, the number of homogenization passes is 4 to 5, the material outflow rate is 10 L/h to 30 L/h, the homogenization time is 5 h to 25 h, and the homogenization pressure is 10 MPa to 20 MPa.

(3) Adding 87.5 to 99.8 parts of polyurethane polymer into the material subjected to the first homogenization process, and performing a second emulsification process to obtain a second emulsified mixture. In the second emulsification process, the dispersion speed is 6,000 rpm to 10,000 rpm, and the emulsification time is 5 min to 15 min.

(4) Performing a second homogenization process on the second emulsified mixture, so as to obtain a composition of a composite conductive adhesive and water after completion of the second homogenization process. In the second homogenization process, the number of homogenization passes is 3 to 7, the material outflow rate is 10 L/h to 30 L/h, and the homogenization pressure is 10 MPa to 20 MPa.

The total number of homogenization passes is a sum of the number of homogenization passes in the first homogenization process and the number of homogenization passes in the second homogenization process. The homogenization that includes a first homogenization process and a second homogenization process is merely an example. If a third homogenization process is further included, the number of homogenization passes in the third homogenization process is also included in the total number of homogenization passes. Additional homogenization processes are deduced by analogy, details of which are omitted here. The equipment used for the emulsification and shearing process and the homogenization process is not particularly limited herein, as long as the objectives of this application can be achieved. The composite conductive adhesive of this application is obtained through the above emulsification-shearing process and homogenization process. The resulting composite conductive adhesive exists in the form of an aqueous dispersion of the composite conductive adhesive, and can be adjusted until the solid content is appropriate for direct use in the preparation of a negative electrode slurry. Alternatively, those skilled in the art may dry the composite conductive adhesive according to actual needs to obtain solid particles of the composite conductive adhesive. In preparing a negative electrode plate, a solvent is added into the solid particles to formulate an aqueous dispersion of the composite conductive adhesive with a solid content of 1.5% to 20%, ready for use in the preparation of the negative electrode slurry. This is not particularly limited herein, as long as the objectives of this application can be achieved. The drying may be performed at a temperature of 80 °C to 120 °C for a duration of 2 h to 10 h.

This application further provides an aqueous dispersion of a composite conductive adhesive. The aqueous dispersion of a composite conductive adhesive includes the composite conductive adhesive provided in the first aspect of this application and a solvent. Based on the mass of the aqueous dispersion of the composite conductive adhesive, the mass percentage of the composite conductive adhesive is 1.5% to 20%, and the mass percentage of the solvent is 80% to 98.5%. For example, the mass percentage of the composite conductive adhesive may be 1.5%, 5%, 8%, 10%, 12%, 15%, 18%, 20%, or a value falling within a range formed by any two thereof, and the mass percentage of the solvent may be 80%, 85%, 88%, 90%, 93%, 95%, 98.5%, or a value falling within a range formed by any two thereof. The solvent includes at least one of deionized water, ethanol, or acetone. When a negative electrode plate is prepared from the aqueous dispersion of a composite conductive adhesive satisfying the above characteristics, the carbon nanotubes in the composite conductive adhesive can be dispersed more uniformly within the negative electrode material layer, thereby more favorably exerting the function of the composite conductive adhesive, and consequently improving the cycling performance and cycling expansion performance of the secondary battery.

A third aspect of this application provides a secondary battery. The secondary battery includes a positive electrode plate and a negative electrode plate. The negative electrode plate includes a negative current collector and a negative electrode material layer disposed on at least one surface of the negative current collector. The negative electrode material layer includes the composite conductive adhesive provided in any one of the above embodiments or a composite conductive adhesive prepared using the preparation method provided in any one of the above embodiments. The negative electrode material layer includes the above composite conductive adhesive, thereby not only facilitating the formation of a conductive network in the negative electrode material layer, and improving the conductivity of the negative electrode material layer, but also endowing the negative electrode material layer with high adhesiveness, and alleviating expansion of the silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

In some embodiments of this application, the negative electrode material layer further includes a silicon-containing material. The silicon-containing material includes at least one of silicon, a silicon-carbon compound, or a silicon-oxygen compound. Based on a mass of the negative electrode material layer, the mass percentage of silicon is M %, satisfying: 10≤M≤60. For example, the value of M may be 10, 12, 15, 17, 20, 30, 40, 50, 60, or a value falling within a range formed by any two thereof. Selecting the silicon-containing material within the above range and controlling the mass percentage of silicon to fall within the above range endow the secondary battery with a relatively high energy density, and make it more convenient to exert the effect of the composite conductive adhesive in the silicon negative electrode system, thereby improving the cycling performance and cycling expansion performance of the secondary battery.

Generally, the mass percentage M % of silicon in the negative electrode material layer may be adjusted by adjusting either the mass percentage of the silicon-containing material in the negative electrode material layer or the mass percentage of silicon in the silicon-containing material. With the silicon mass percentage kept constant in the silicon-containing material, an increased mass percentage of the silicon-containing material in the negative electrode material layer increases M %, and a reduced mass percentage of the silicon-containing material in the negative electrode material layer decreases M %. With the mass percentage of the silicon-containing material kept constant in the negative electrode material layer, an increased mass percentage of silicon in the silicon-containing material increases M %, and a reduced mass percentage of silicon in the silicon-containing material decreases M %.

In some embodiments of this application, based on the mass of the negative electrode material layer, the mass percentage of the composite conductive adhesive is Q %, satisfying: 1.2≤Q≤11.5. For example, the value of Q may be 1.2, 2, 4, 5, 6, 8, 10, 11.5, or a value falling within a range formed by any two thereof. By controlling the mass percentage of the composite conductive adhesive to fall within the above range, this application achieves high adhesion between particles of the negative active material, thereby not only facilitating the formation of a conductive network in the negative electrode material layer, improving the ion transmission capability of the negative electrode material layer, but also endowing the negative electrode material layer with high adhesiveness, and alleviating expansion of the silicon-containing material. This alleviates the problems of detachment and pulverization of the negative electrode material layer caused by insufficient adhesion or silicon expansion during cycling of the secondary battery, thereby improving the cycling performance and cycling expansion performance of the secondary battery.

In this application, the negative electrode material layer may be disposed on one surface of the negative current collector in a thickness direction or on both surfaces of the negative current collector in the thickness direction. It is hereby noted that the “surface” here may be the entire region of the negative current collector, or a partial region of the negative current collector, without being particularly limited herein, as long as the objectives of the application can be achieved. The negative current collector is not particularly limited herein, as long as the objectives of this application can be achieved. For example, the negative current collector may include copper foil, copper alloy foil, nickel foil, stainless steel foil, titanium foil, foamed nickel, foamed copper, or composite current collector. As an example, the composite current collector may be a lithium-copper composite current collector, a carbon-copper composite current collector, a nickel-copper composite current collector, or a titanium-copper composite current collector. The thicknesses of the negative current collector and the negative electrode material layer are not particularly limited herein, as long as the objectives of this application can be achieved. For example, the thickness of the negative current collector is 4 μm to 12 μm, and the thickness of the negative electrode material layer on a single side is 30 μm to 160 μm.

In this application, the negative electrode material layer may further include graphite and a negative electrode dispersant. The graphite may include at least one of natural graphite or artificial graphite. The negative electrode dispersant may be at least one of the above-mentioned dispersants. Based on the mass of the negative electrode material layer, the mass percentage of graphite is 0% to 88%, the mass percentage of the silicon-containing material is 10% to 98%, and the mass percentage of the negative electrode dispersant is 0.3% to 1.5%.

The method for preparing the negative electrode plate is not particularly limited herein, as long as the objectives of this application can be achieved. For example, the negative electrode plate may be prepared by the following method: mixing a negative active material and a dispersant, adding an aqueous dispersion of a composite conductive adhesive, and then adding a solvent and stirring well to obtain a negative electrode slurry with a solid content of 15 wt % to 45 wt %. Applying the negative electrode slurry evenly on one surface of the negative current collector, and oven-drying the slurry to obtain a negative electrode plate coated with a negative electrode material layer on a single side. Subsequently, repeating the above coating steps on the other surface of the negative current collector, and oven-drying the current collector to obtain a negative electrode plate coated with a negative electrode material layer on both sides. Cold-pressing and cutting the coated negative electrode plate to obtain a negative electrode plate.

Understandably, the negative electrode material layer may include a conductive agent. The conductive agent added to the negative electrode material layer promotes the formation of a conductive network in the negative electrode plate and improves the conductivity of the negative electrode material layer. The conductive agent may be one or more of (single-walled, multi-walled, or few-walled) carbon nanotubes, conductive carbon black, or graphene. Based on the mass of the negative electrode material layer, the mass percentage of the conductive agent is 0% to 0.5%. The negative electrode material layer may further include a binder. The type of the binder is not particularly limited herein, as long as the objectives of this application can be achieved. For example, the binder may include, but is not limited to, at least one of polyacrylic acid, sodium polyacrylate, potassium polyacrylate, lithium polyacrylate, polyimide, polyvinyl alcohol, carboxymethyl cellulose, sodium carboxymethyl cellulose, lithium carboxymethyl cellulose, polyamide imide, styrene-butadiene rubber, or polyvinylidene fluoride. The binder included in the negative electrode slurry layer further improves the structural stability of the negative electrode material layer, and alleviates the problems of detachment and pulverization of the negative electrode material layer caused by insufficient adhesion or silicon expansion during cycling of the secondary battery, thereby improving the cycling performance and cycling expansion performance of the secondary battery. Based on the mass of the negative electrode material layer, the mass percentage of the binder is 0% to 5%.

The secondary battery of this application further includes a positive electrode plate. The positive electrode plate is not particularly limited herein, as long as the objectives of this application can be achieved. For example, the positive electrode plate includes a positive current collector and a positive electrode material layer disposed on at least one surface of the positive current collector. In this application, the positive electrode material layer may be disposed on one surface of the positive current collector in a thickness direction or on both surfaces of the positive current collector in the thickness direction. It is hereby noted that the “surface” here may be the entire region of the surface of the positive current collector, or a partial region of the surface of the positive current collector, without being particularly limited herein, as long as the objectives of the application can be achieved. The positive current collector is not particularly limited herein, as long as the objectives of this application can be achieved. For example, the positive current collector may include aluminum foil, aluminum alloy foil, a composite current collector (such as an aluminum carbon composite current collector), or the like. The thicknesses of the positive current collector and positive electrode material layer are not particularly limited herein, as long as the objectives of this application can be achieved. For example, the thickness of the positive current collector is 5 μm to 20 μm. The thickness of the positive electrode material layer on a single side is 30 μm to 120 μm.

In this application, the positive electrode material layer includes a positive active material. The type of the positive active material is not particularly limited herein as long as the objectives of this application can be achieved. The positive active material may include at least one of lithium nickel cobalt manganese oxide (such as NCM811, NCM622, NCM523, NCM111), lithium nickel cobalt aluminum oxide, lithium iron phosphate, a lithium-rich manganese-based material, lithium cobalt oxide, lithium manganese oxide, lithium manganese iron phosphate, or the like. The positive electrode material layer of this application may further include a conductive agent and a positive electrode binder. The conductive agent is not particularly limited herein, as long as the objectives of this application can be achieved. For example, the conductive agent may include, but is not limited to, at least one of conductive carbon black (Super P), carbon nanotubes, flake graphite, carbon fiber, graphene, amorphous carbon, hard carbon, soft carbon, glassy carbon, carbon nanofiber, a metal material, or a conductive polymer. The conductive carbon black may include, but is not limited to, at least one of acetylene black or Ketjen black. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The positive electrode binder is not particularly limited herein, as long as the objectives of this application can be achieved. For example, the positive electrode binder may include, but is not limited to, at least one of polyacrylic acid, polyacrylic acid sodium, polyacrylic acid potassium, polyacrylic acid lithium, polyimide, polyvinyl alcohol, carboxymethyl cellulose, sodium carboxymethyl cellulose, lithium carboxymethyl cellulose, polyamide imide, styrene butadiene rubber, or polyvinylidene difluoride.

The method for preparing the positive electrode plate is not particularly limited herein as long as the objectives of this application can be achieved. For example, the positive electrode plate may be prepared by the following method: mixing a positive active material, a positive conductive agent, and a positive electrode binder, adding N-methylpyrrolidone (NMP), and stirring well to obtain a positive electrode slurry. Applying the positive electrode slurry evenly onto one surface of the positive current collector, and oven-drying the slurry to obtain a positive electrode plate coated with a positive electrode material layer on a single side. Subsequently, repeating the above coating steps on the other surface of the positive current collector, and oven-drying the current collector to obtain a positive electrode plate coated with a positive electrode material layer on both sides. Cold-pressing and cutting the coated positive electrode plate to obtain a positive electrode plate. The mass ratio between the positive active material, the conductive agent, and the binder in the positive electrode material layer is not particularly limited herein, as long as the objectives of this application can be achieved.

The secondary battery according to this application further includes an electrolyte solution. The electrolyte solution in this application may include a lithium salt and a nonaqueous solvent. The type of the lithium salt is not particularly limited herein as long as the objectives of this application can be achieved. For example, the lithium salt may include, but is not limited to, at least one of lithium hexafluorophosphate (LiPF₆), lithium tetrafluoroborate (LiBF₄), lithium difluorophosphate (LiPO₂F₂), lithium bis(trifluoromethanesulfonyl)imide (LiTFSI), lithium bis(fluorosulfonyl)imide (LiFSI), lithium bis(oxalato)borate (LiBOB), or lithium difluoro(oxalato)borate (LiDFOB). The type of the nonaqueous solvent is not particularly limited herein, as long as the objectives of this application can be achieved. For example, the nonaqueous solvent may include, but is not limited to, at least one of a carbonate compound, a carboxylate compound, an ether compound, or other nonaqueous solvents. The carbonate compound may include, but is not limited to, at least one of a chain carbonate compound or a cyclic carbonate compound. The chain carbonate compound may include, but is not limited to, at least one of dimethyl carbonate, diethyl carbonate (DEC), dipropyl carbonate, methyl propyl carbonate, ethylene propyl carbonate, or ethyl methyl carbonate. The cyclic carbonate ester compound may include, but is not limited to, at least one of ethylene carbonate (EC), propylene carbonate (PC), butylene carbonate, or vinyl ethylene carbonate. The carboxylate compound may include, but is not limited to, at least one of methyl formate, methyl acetate, ethyl acetate, n-propyl acetate, tert-butyl acetate, methyl propionate, ethyl propionate (EP), propyl propionate, γ-butyrolactone, decanolactone, valerolactone, or caprolactone. The ether compound may include, but is not limited to, at least one of ethylene glycol dimethyl ether, dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above-mentioned other nonaqueous solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The secondary battery of this application further includes a separator. The separator is not particularly limited herein, as long as the objectives of this application can be achieved. For example, the separator may be made of a material including but not limited to at least one of: a polyethylene (PE)- or polypropylene (PP)-based polyolefin (PO), a polyester (such as polyethylene terephthalate (PET) film), cellulose, polyimide (PI), polyamide (PA), spandex, or aramid. The type of the separator may include a woven film, a nonwoven film, a microporous film, a composite film, a calendered film, or a spinning film. In some embodiments, the separator may include a substrate layer and a surface treatment layer. The substrate layer may be a nonwoven fabric or a composite film, which, in each case, assumes a porous structure. The material of the substrate layer may include at least one of polyethylene, polypropylene, polyethylene terephthalate, or polyimide. Optionally, the substrate layer may be a polypropylene porous film, a polyethylene porous film, a polypropylene non-woven fabric, a polyethylene non-woven fabric, or a polypropylene-polyethylene-polypropylene porous composite film. In this application, the thickness of the separator is not particularly limited herein, as long as the objectives of this application can be achieved. For example, the thickness of the separator may be 3 μm to 30 μm.

The secondary battery further includes a housing. The housing is configured to accommodate a positive electrode plate, a separator, a negative electrode plate, an electrolyte solution, and other components known in the art for use in the secondary battery. The other components are not limited herein. The housing is not particularly limited herein, and may be a housing well-known in the art, as long as the objectives of this application can be achieved. For example, the housing may be a hard housing or a flexible housing. The material of the hard housing may be metal. The type of the metal is not limited herein. The hard housing may be a metallic hard housing known in the art as long as the objectives of this application can be achieved. The flexible housing may be a metallic laminated film such as an aluminum laminated film, a steel laminated film.

The process of preparing the secondary battery of this application is well known to a person skilled in the art, and is not particularly limited herein. For example, the preparation process of the secondary battery may include, but is not limited to, the following steps: stacking the positive electrode plate, the separator, and the negative electrode plate in sequence, performing operations as required such as winding and folding to obtain a jelly-roll electrode assembly, putting the electrode assembly into a housing, injecting the electrolyte solution into the housing, and sealing the housing to obtain a secondary battery. Alternatively, the steps are as follows: stacking the positive electrode plate, the separator, and the negative electrode plate in sequence, and then fixing the four corners of the entire stacked structure by use of adhesive tape to obtain a stacked-type electrode assembly, putting the electrode assembly into a housing, injecting the electrolyte solution into the housing, and sealing the housing to obtain a secondary battery. In addition, an overcurrent protection element, a conductive plate, and the like as required may be placed into a housing, so as to prevent the rise of internal pressure, overcharge, and overdischarge of the secondary battery.

The secondary battery is not particularly limited in this application, and may be any device in which an electrochemical reaction occurs. For example, the types of the secondary battery may include, but are not limited to, a lithium metal secondary battery, a lithium-ion secondary battery (lithium-ion battery), a lithium polymer secondary battery, or a lithium-ion polymer secondary battery.

A fourth aspect of this application provides an electronic device. The electronic device includes the secondary battery provided in any one of the above embodiments. Therefore, the electronic device of this application exhibits a relatively long lifespan.

The type of the electronic device is not particularly limited herein, and may be any electronic device known in the prior art. In some embodiments of this application, the types of the electronic device may include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, or the like.

### EMBODIMENTS

The implementations of this application are described below in more detail with reference to some embodiments and comparative embodiments. Various tests and evaluations are performed by the following methods. In addition, unless otherwise specified, the word “parts” means parts by mass, and the symbol “%” means a percentage by mass.

### Test Methods and Devices

### Method for Preparing a Film of a Composite Conductive Adhesive

Preparing a composite conductive adhesive according to the preparation methods of each embodiment and comparative embodiment. Adding the composite conductive adhesive into deionized water to formulate an aqueous dispersion with a solid content of 10 wt %. Casting the aqueous dispersion into a mold, and then performing oven-drying at 80 °C for 4 hours to obtain a film. All the films used in the following tests of a film of the composite conductive adhesive are prepared according to the above steps.

### Scanning Electron Microscopy Test

Observing a specimen using a Philips XL-30 field emission scanning electron microscope (SEM), where the accelerating voltage is set to 10 kV, and the emission current is set to 10 mA. For Comparative Embodiment 1-7 below, the SEM test specimen is a thin film prepared by: making a raw material of carbon nanotubes into a carbon nanotube slurry, casting the slurry into a mold, and then performing drying at 80 °C for 4 hours.

### (1) Non-Curvature Ratio Test

Observing the film through SEM, and taking an SEM image at an appropriate magnification. Calculating the non-curvature ratio of the carbon nanotubes as:

$$N = \frac{{N}_{1}}{{N}_{1} + {N}_{2}} ,$$

where N₁ and N₂ are determined by the following method: connecting the two ends of a carbon nanotube to form a straight line L₁; selecting an endpoint with a larger curvature of the carbon nanotube as a head of the carbon nanotube, and drawing a tangent line L₂ that is tangent to the carbon nanotube at the head; denoting an angle between the straight line L₁ and the tangent line L₂ as θ₀; and recording the number of carbon nanotubes with θ₀ less than or equal to 5° as N₁, and recording the number of carbon nanotubes with θ₀ greater than 5° as N₂. Selecting 100 carbon nanotubes randomly to calculate the non-curvature ratio N. The appropriate magnification means a magnification at which both ends of the carbon nanotube can be observed within the SEM field of view.

### (2) Test of the Length of Carbon Nanotubes

Dispersing a powder raw material of carbon nanotubes in deionized water to obtain a dilution with a solid content of 0.1 wt %. Dripping the dilution onto a silicon wafer. Observing the dilution through SEM. Selecting 100 carbon nanotubes randomly, measuring the lengths of the carbon nanotubes, and calculating an average value thereof as a length L₀ of the carbon nanotubes in the powder raw material of the carbon nanotubes.

Dispersing the composite conductive adhesive in deionized water to obtain a dilution with a solid content of 0.1 wt %. Dripping the dilution onto a silicon wafer. Observing the dilution through SEM. Selecting 100 nanotubes randomly, measuring the lengths of the carbon nanotubes, and calculating an average value thereof as a length L_{c} of the carbon nanotubes in the composite conductive adhesive.

### (3) Test of an Average Particle Diameter of Emulsion Particles

Dispersing a raw material of a polymer in deionized water to obtain a dilution with a solid content of 0.1 wt %. Dripping the dilution onto a silicon wafer. Drying the dilution at 80 °C to obtain a specimen. Observing and testing the specimen through SEM to obtain a maximum size of the emulsion particles in the raw material of the polymer, and recording the maximum size as a diameter. Selecting 20 emulsion particles randomly, measuring the diameters of the particles, and calculating the average value thereof to obtain an average particle diameter of the emulsion particles.

### (4) Test of Mass Percentage of Silicon

Disassembling a lithium-ion battery, and taking out a negative electrode plate. Fixing the negative electrode plate to a specimen stage using conductive carbon adhesive, and placing the specimen stage onto a holder. Place the holder and the specimen stage into a cross-section polisher (CP), evacuating to 10⁻⁴ Pa, and then cutting the negative electrode plate specimen along the thickness direction of the negative electrode plate using argon gas. Placing the CP-cut specimen onto an SEM specimen stage, with the cross-section of the specimen facing upward. Observing the specimen using a Philips XL-30 field-emission scanning electron microscope (SEM) at a magnification of 1000×. Measuring the mass percentage M % of silicon in the negative electrode material layer using an energy-dispersive X-ray spectrometer (EDS) attached to the SEM.

### Transmission Electron Microscopy (TEM) Test

Observing and testing a dilution of a composite conductive adhesive with a solid content of 0.01 wt % through a Zeiss Libra 200MC transmission electron microscope. For Comparative Embodiment 1-7 below, a raw material of carbon nanotubes may be diluted to obtain a dilution with a solid content of 0.01 wt % for observation and testing.

### Test of Composition of a Composite Conductive Adhesive

Using a pyrolysis gas chromatography mass spectrometry (pyGC-MS) instrument to test a composite conductive adhesive to obtain the types and mass percentage of polymers and dispersants in the composite conductive adhesive, and determining the mole percentage of the monomer units in the polymer through analysis. Drying a composite conductive adhesive in an 80 °C oven for 8 hours. Testing the dried composite conductive adhesive in the pyGC-MS instrument, where the instrument model is Agilent 7890B/5977B, the detector is a mass selective detector (MSD), the injector is a pyrolyzer EGA/PY-3030D, the column oven temperature is 40 °C to 320 °C, and the pyrolyzer temperature is 40 °C to 800 °C.

Performing a test through a simultaneous thermal analyzer (model: STA449F3) under an air atmosphere by heating from room temperature to 1200 °C at a rate of 10 °C/min. Using the proportion of weight loss during heating from 600 °C to 1200 °C as the mass percentage of carbon nanotubes in the composite conductive adhesive.

### pH Test

Taking an emulsion raw material of a polymer, and testing the pH value of the raw material of the polymer using a pH meter (supplied by Shanghai Leici PHB-4).

### Test of a Reduction Curve

Coating 6 m-thick copper foil with a raw material of a polymer in the composite conductive adhesive to make a working electrode, where the coating thickness is 15 μm. Making a negative electrode steel shell, a spring sheet, and a positive electrode steel shell readily available. Using a lithium sheet as a counter electrode, and using a polyethylene film as a separator. Stacking the negative electrode steel shell, the spring sheet, the working electrode, the separator, the counter electrode, and the positive electrode steel shell in sequence, injecting an electrolyte solution, and then assembling the electrodes to form a coin cell. The electrolyte solution, the copper foil, and the separator used here are the same as those in Embodiment 1-1.

Performing a charge-discharge test on the coin cell in an electrochemical workstation (model: 1470E/1455, supplied by Solartron) by means of cyclic voltammetry, so as to obtain a reduction curve of the polymer. In the charge-discharge test, the voltage window is set to 0 V to 3 V, the scan rate is 0.1 mV/s, and the number of cycles is 3.

### Test of Atomic Mass Percentage of Polar Functional Groups

Using gel permeation chromatography (GPC) to characterize the weight-average molecular weight (Mw) of the polymer, where the GPC instrument is an Agilent 1260 HPLC gel chromatograph equipped with a refractive index detector (RID) and a 79911GP-502 chromatographic column. The specific procedures include: dispersing 5 mg of the polymer specimen in 2 mL of deionized water (HPLC grade), where the column temperature is 30 °C, the mobile phase is HPLC-grade water, and the flow rate is 1.0 mL·min⁻¹.

Testing and characterizing the polymer using a Nicolet iS50 Fourier transform infrared spectrometer and an HLD-NMR-II nuclear magnetic resonance spectrometer. Analyzing the test results to obtain a total atomic mass of the polar functional groups in the polymer, denoted as m, and calculating the percentage as X=m/Mw.

### Test of Swelling Ratio

Taking a specimen of a raw material of a polymer, measuring the mass of the specimen, denoted as W0, and then immersing the specimen in an electrolyte solution at 60 °C to 70 °C for 48 hours (h). Taking out the specimen, wiping off the solvent on the surface of the specimen, and measuring the mass of the swollen specimen, denoted as W1. Measuring the mass of each specimen three times during the test. Calculating the swelling degree of the polymer as: swelling degree=(W1−W0)/W0×100%. The electrolyte solution used here is the same as that in Embodiment 1-1.

### Test of Elongation-at-Break and Tensile Strength

Adding a raw material of a polymer into deionized water to formulate a slurry with a solid content of 6 wt %. Casting the slurry into a mold, and then performing drying at 80 °C for 4 hours to obtain a film of the polymer. Preparing a film of a composite conductive adhesive according to the above-mentioned preparation method for the film of the composite conductive adhesive.

Testing the elongation-at-break and the tensile strength of the film of the polymer and the film of the composite conductive adhesive using a universal tensile tester. Measuring the elongation-at-break and the tensile strength according to the Chinese national standard GB/T 30776-2014 Test Method for Tensile Strength and Elongation at break of Adhesive Tapes. Cutting the film into specimens of 2 cm (length)×1 cm (width)×0.01 cm (height). Clamping a specimen between an upper grip and a lower grip of the universal tensile tester, where an initial distance between the fixed upper grip and lower grip is L₀, an initial length of the specimen is L₀. Pulling the upper and lower grips at a constant rate of 50 mm/min until the specimen breaks. Recording the distance between the upper grip and the lower grip at the moment of break of the specimen as L₁. Calculating the elongation-at-break as: L=(L₁−L₀)/L₀×100%. Denoting the tensile force at the time of breakage of the specimen as F, and calculating the tensile strength as: tensile strength=F/S, where S=width×thickness=1 cm×0.01 cm.

### Raman Spectroscopy Test

Performing Raman spectroscopy using a Raman spectrometer (Jobin Yvon LabRAM HR), where the excitation source is a light source with a wavelength of 532 nm, and the test range is 0 cm⁻¹ to 4000 cm⁻¹. Preparing a specimen of the raw material of the carbon nanotubes for the Raman spectroscopy test by making a film of the raw material according to the method used in the above SEM test. Using the film of the composite conductive adhesive as a specimen for the Raman spectroscopy test, where the area of the specimen tested is 100 μm×100 μm.

### Viscosity Test

Dispersing a composite conductive adhesive in water by stirring for 2 minutes at a temperature of 25 °C and a rotation speed of 12 rpm to form an aqueous dispersion of the composite conductive adhesive in which the mass percentage of the composite conductive adhesive is 9%. Measuring the viscosity of the aqueous dispersion of the composite conductive adhesive by use of a digital rotational viscometer (Shanghai Jingtian Electronic Instrument Co., Ltd., LVDV-1). Selecting a rotor and a rotation speed as appropriate for the aqueous dispersion of the composite conductive adhesive to be measured. Tilting and immersing the rotor slowly in the aqueous dispersion of the composite conductive adhesive to allow wetting, and ensuring that air bubbles do not form at the bottom of the rotor. Starting the rotational viscometer when the liquid level of the aqueous dispersion of the composite conductive adhesive reaches a middle position of the groove of the rotor. Waiting for three minutes until the readout keeps constant, and recording the readout as a viscosity of the aqueous dispersion of the composite conductive adhesive, in units of mPa·s.

### Test of Cycling Performance and Cycling Expansion Performance

Evaluating the cycling performance and cycling expansion performance of a lithium-ion battery by measuring the capacity retention rate and the expansion rate of the lithium-ion battery cycled for 500 cycles. Charging a lithium-ion battery at a constant current of 1.0 C at 25 °C until a charge cut-off voltage 4.53 V, and then continuing to charge the battery at a constant voltage of 4.53 V until a cut-off current 0.05C. Subsequently, discharging the lithium-ion battery at a constant current of 0.7C until a discharge cut-off voltage 3.0 V, thereby completing one charge-discharge cycle. Repeating the above operations for 500 cycles. Recording a first-cycle initial discharge capacity C₁ and a 500^{th}-cycle discharge capacity C₂. Calculating the capacity retention rate of the lithium-ion battery cycled for 500 cycles as: capacity retention rate (%)=C₂/C₁×100%. Using a micrometer to measure the thickness of the lithium-ion battery when the battery is initially charged to 4.53 V, denoted as H₀. Measuring the thickness of the battery at the end of charging in the 500^{th} cycle, denoted as H₁. Taking the same measurement point on each battery for measurement, measuring the thickness at each measurement point three times, and using the average value as a test result. Expansion rate (%) of a lithium-ion battery cycled for 500 cycles=(H₁−H₀)/H₀×100%.

In a lithium-ion battery used as an example in this application, the charge cut-off voltage is 4.53 V and the discharge cut-off voltage is 3.0 V. The charge cut-off voltage and the discharge cut-off voltage of the lithium-ion battery may be determined based on the printing on the outer packaging of the battery at the time of factory shipment.

### Embodiment 1-1

### Preparation of a Composite Conductive Adhesive

(1) Adding 6 parts of carboxymethyl cellulose (CMC) as a dispersant and 990 parts of deionized water as a solvent into an emulsifier (model: HR-25, supplied by Shanghai HUXI) for dispersion. Setting a dispersion speed to 10,000 rpm and setting the dispersion time to 15 min. Subsequently, adding a total of 4 parts of carbon nanotube raw material (single-walled carbon nanotubes, with each carbon nanotube being 2 nm in diameter) in 5 portions, and adding 0.8 part each time. Emulsifying the carbon nanotube raw material after each addition, where each emulsification process is performed for 10 min at a speed of 10,000 rpm, so as to obtain a first emulsified mixture after completion of emulsification.

(2) Adding the first emulsified mixture into a homogenizer (Deheng Nano DNH-340) through a high-pressure pump for undergoing a first homogenization process. In the first homogenization process, the number of homogenization passes is 4, the material outflow rate is 20 L/h, and the homogenization pressure is 15 MPa.

(3) Adding 90 parts of polyurethane polymer (Mw=30,000 g/mol, the composition of polyurethane and the relevant parameters of the raw material are shown in Table 2) and 60 parts of water into the material subjected to the first homogenization process, and performing a second emulsification process to obtain a second emulsified mixture. In the second emulsification process, the emulsification rotation speed is 8,000 rpm, and the emulsification time is 10 min.

(4) Performing a second homogenization process on the second emulsified mixture, so as to obtain a composition of a composite conductive adhesive and water after completion of the second homogenization process. In the second homogenization process, the number of homogenization passes is 5, the material outflow rate is 20 L/h, and the homogenization pressure is 15 MPa.

Based on the mass of the composite conductive adhesive, the mass percentage of the polymer, the mass percentage of the carbon nanotubes, and the mass percentage of the dispersant are shown in Table 1.

### Preparation of a Negative Electrode Plate

Adding a composition of the above-prepared composite conductive adhesive and water into a deionized water solvent to formulate an aqueous dispersion of the composite conductive adhesive with a solid content of 10 wt %.

Mixing a silicon-carbon compound as a silicon-containing material (in which the mass ratio of silicon to carbon is 50:50), graphite, single-walled carbon nanotubes as a conductive agent, and sodium carboxymethyl cellulose (Mw=35,000) as a dispersant. Adding the aqueous dispersion of the composite conductive adhesive and stirring well, and then adding deionized water as a solvent to formulate a slurry with a solid content of 36 wt %. Stirring well in a vacuum mixer to obtain a negative electrode slurry. Applying the negative electrode slurry evenly onto one surface of 6 m-thick negative current collector copper foil, and drying the foil at 120 °C to obtain a negative electrode plate coated with a negative electrode material layer on a single side, where the coating weight of the negative electrode material layer is 100 mg/1540 mm². Subsequently, repeating the above steps on the other surface of the copper foil to obtain a negative electrode plate coated with the negative electrode material layer on both sides. Drying the electrode plate at 120 °C, and then performing cold-pressing, cutting, and tab welding to obtain a negative electrode plate of 78 mm×875 mm in size for future use. The thickness of the negative electrode material layer on a single side is 35 μm. Based on the mass of the negative electrode material layer, the mass percentage of the silicon-containing material is 40%, the mass percentage of the dispersant is 1.0%, the mass percentage of the composite conductive adhesive, denoted as Q %, is 5%, the mass percentage of the conductive agent is 0.2%, and the remainder is graphite. The mass percentage of silicon, denoted as M %, is 20%.

### Preparation of a Positive Electrode Plate

Mixing lithium cobalt oxide as a positive active material, conductive carbon black as a conductive agent, and polyvinylidene fluoride as a binder at a mass ratio of 97.9:0.9:1.2, adding N-methyl-pyrrolidone (NMP) as a solvent to formulate a slurry in which the solid content is 75 wt %, and stirring well in vacuum to obtain a positive electrode slurry. Applying the positive electrode slurry evenly onto one surface of 10 m-thick positive current collector aluminum foil, and drying the foil at 120 °C to obtain a positive electrode plate coated with a positive electrode material layer on a single side, where the coating weight of the positive electrode material layer is 250 mg/1540 mm². Subsequently, repeating the above steps on the other surface of the aluminum foil to obtain a positive electrode plate coated with the positive electrode material layer on both sides. Performing oven-drying at 120 °C, and then performing cold-pressing, cutting, and tab welding to obtain a positive electrode plate of 74 mm×867 mm ready for use. The thickness of the positive electrode material layer on a single side is 42 μm.

### Separator

Using a 15 μm-thick polyethylene film as a separator.

### Preparation of an Electrolyte Solution

Mixing dimethyl carbonate, diethyl carbonate, and ethylene carbonate at a mass ratio of 1:1:1 in an environment in which the water content is less than 10 ppm, and stirring well to obtain a nonaqueous solvent. Subsequently, adding LiPF₆ as an electrolyte salt into the nonaqueous solvent, and stirring well to obtain an electrolyte solution. Based on the mass of the electrolyte solution, the mass percentage of the electrolyte salt is 12.5%, and the remainder is the nonaqueous solvent.

### Preparation of a Lithium-Ion Battery

Stacking the prepared positive electrode plate, separator, and negative electrode plate in sequence such that the separator is located between the positive electrode plate and the negative electrode plate to serve a function of separation, and then winding the stacked structure to obtain an electrode assembly. Welding tabs to the electrode assembly, and then placing the electrode assembly into an aluminum laminated film packaging bag, and then dehydrating the packaged electrode assembly an 85 °C vacuum oven for 12 hours. Injecting the above-prepared electrolyte solution into the electrode assembly. Performing the steps such as vacuum sealing, standing, formation (charging the battery at a constant current of 0.02C until the voltage reaches 3.5 V, and then charging the battery at a constant current of 0.1C until the voltage reaches 3.9 V), shaping, capacity grading, and secondary packaging to obtain a lithium-ion battery.

### Embodiments 1-2 to 1-13

Identical to Embodiment 1-1 except that the relevant parameters are adjusted according to Table 1. The total number of homogenization passes is made compliant with Table 1 by adjusting the number of homogenization passes in the second homogenization process, and the number of homogenization passes in the first homogenization process remains unchanged.

### Embodiments 2-1 to 2-11

Identical to Embodiment 1-1 except that the relevant parameters are adjusted according to Table 2.

### Embodiments 2-12 to 2-13

Identical to Embodiment 1-1 except that polyurethane prepared by adding a chain extender 1,6-hexanediol during polymerization is used as the polymer, and the relevant parameters of the polymer are adjusted according to Table 2 to make the value of X compliant with Table 2. 20 parts of chain extender are added in Embodiment 2-12, and 5 parts of chain extender are added in Embodiment 2-13.

### Embodiments 3-1 to 3-8

Identical to Embodiment 1-1 except that the mass ratio of silicon to carbon in the silicon-containing material and/or the mass percentage of the material are adjusted to make the mass percentage M % of silicon compliant with Table 3, and the mass percentage Q % of the composite conductive adhesive is adjusted according to Table 3. When the mass percentage of the silicon-containing material and/or the mass percentage of the composite conductive adhesive changes, the mass percentage of the graphite changes accordingly while the mass percentage of the dispersant remains unchanged.

### Comparative Embodiment 1-1

Identical to Embodiment 1-1 except that, in <Preparation of a composite conductive adhesive>, the polyurethane is replaced with styrene-butadiene rubber (Mw=150,000 g/mol), and the number of homogenization passes is adjusted according to Table 1.

### Comparative Embodiment 1-2

Identical to Embodiment 1-1 except that, in <Preparation of a composite conductive adhesive>, the polyurethane is replaced with styrene-butadiene rubber (Mw=150,000 g/mol).

### Comparative Embodiments 1-3 to 1-6

Identical to Embodiment 1-1 except that the relevant parameters are adjusted according to Table 1.

### Comparative Embodiment 1-7

Identical to Embodiment 1-1 except that the negative electrode plate is prepared by a method described in <Preparation of a negative electrode plate> below.

### Preparation of a Negative Electrode Plate

Mixing a silicon-carbon compound as a silicon-containing material (in which the mass ratio of silicon to carbon is 50:50), graphite, sodium carboxymethyl cellulose (Mw=35,000) as a dispersant, polyurethane as a binder, and single-walled carbon nanotubes as a conductive agent. Adding deionized water as a solvent to formulate a slurry with a solid content of 36 wt %. Stirring well in a vacuum mixer to obtain a negative electrode slurry. Applying the negative electrode slurry evenly onto one surface of 6 μm-thick negative current collector copper foil, and drying the foil at 120 °C to obtain a negative electrode plate coated with a negative electrode material layer on a single side, where the coating weight of the negative electrode material layer is 100 mg/1540 mm². Subsequently, repeating the above steps on the other surface of the copper foil to obtain a negative electrode plate coated with the negative electrode material layer on both sides. Drying the electrode plate at 120 °C, and then performing cold-pressing, cutting, and tab welding to obtain a negative electrode plate of 78 mm×875 mm in size for future use. The thickness of the negative electrode material layer on a single side is 35 μm.

Based on the mass of the negative electrode material layer, the mass percentage of the silicon-containing material is 40%, the mass percentage of the dispersant is 1.0%, the mass percentage of the binder is 4.5%, the mass percentage of the conductive agent is 0.4%, the mass percentage of the dispersant is 1.3%, and the remainder is graphite. The mass percentage of silicon, denoted as M %, is 20%.

### Comparative Embodiment 1-8

Identical to Embodiment 1-1 except that, in <Preparation of a composite conductive adhesive>, the polyurethane is replaced with polyacrylic acid (Mw=30,000 g/mol).

### Comparative Embodiments 2-1 to 2-2

Identical to Embodiment 1-1 except that the relevant parameters are adjusted according to Table 2.

The relevant parameters and performance test results of each embodiment and comparative embodiment are shown in Table 1 to Table 3.

TABLE 1

| | | Mass | | Mass | | | | | | | | Viscosity of |
|---|---|---|---|---|---|---|---|---|---|---|---|---|
| | Non- | percentage | Mass | percentage | | | | | | | | composite |
| | curvature | of | percentage | of | | | | | | | | conductive |
| | ratio N | polymer | of CNT | dispersant | Type of | L₀ | L_{c} | | | | | adhesive |
| | (%) | (%) | (%) | (%) | dispersant | (μm) | (μm) | L_{c}/L₀ | I₀ | I₁ | I₀/I₁ | (mPa · s) |
| Embodiment 1-1 | 91 | 90 | 4 | 6 | CMC | 80 | 10 | 0.125 | 75 | 55 | 1.36 | 3572 |
| Embodiment 1-2 | 80 | 70 | 12 | 18 | CMC | 80 | 10 | 0.125 | 75 | 55 | 1.36 | 5000 |
| Embodiment 1-3 | 87 | 87.5 | 5 | 7.5 | CMC | 80 | 10 | 0.125 | 75 | 55 | 1.36 | 3963 |
| Embodiment 1-4 | 98 | 99.8 | 0.1 | 0.1 | CMC | 80 | 10 | 0.125 | 75 | 55 | 1.36 | 1000 |
| Embodiment 1-5 | 92 | 90 | 4 | 6 | Polypropylene | 80 | 10 | 0.125 | 75 | 55 | 1.36 | 2626 |
| Embodiment 1-6 | 97 | 90 | 4 | 6 | CMC | 40 | 5 | 0.125 | 60 | 50 | 1.20 | 2145 |
| Embodiment 1-7 | 85 | 90 | 4 | 6 | CMC | 120 | 15 | 0.125 | 80 | 52 | 1.54 | 4658 |
| Embodiment 1-8 | 98 | 90 | 4 | 6 | CMC | 120 | 6 | 0.05 | 80 | 53.5 | 1.50 | 2456 |
| Embodiment 1-9 | 81 | 90 | 4 | 6 | CMC | 40 | 20 | 0.5 | 60 | 58 | 1.03 | 5000 |
| Embodiment 1-10 | 90 | 90 | 4 | 6 | CMC | 80 | 10 | 0.125 | 60 | 51 | 1.18 | 3247 |
| Embodiment 1-11 | 92 | 90 | 4 | 6 | CMC | 80 | 10 | 0.125 | 80 | 65 | 1.23 | 3857 |
| Embodiment 1-12 | 82 | 90 | 4 | 6 | CMC | 80 | 14 | 0.175 | 75 | 58 | 1.29 | 4895 |
| Embodiment 1-13 | 93 | 90 | 4 | 6 | CMC | 80 | 7 | 0.086 | 75 | 52 | 1.44 | 2946 |
| Comparative | 62 | 90 | 4 | 6 | CMC | 80 | 3.5 | 0.044 | 75 | 54 | 1.39 | 3228 |
| Embodiment 1-1 | | | | | | | | | | | | |
| Comparative | 55 | 90 | 4 | 6 | CMC | 80 | 10 | 0.125 | 75 | 57 | 1.32 | 6230 |
| Embodiment 1-2 | | | | | | | | | | | | |
| Comparative | 66 | 60 | 16 | 24 | CMC | 80 | 10 | 0.125 | 75 | 55 | 1.36 | 12852 |
| Embodiment 1-3 | | | | | | | | | | | | |
| Comparative | 75 | 80 | 16 | 4 | CMC | 80 | 10 | 0.125 | 75 | 55 | 1.36 | 4757 |
| Embodiment 1-4 | | | | | | | | | | | | |
| Comparative | 95 | 90 | 4 | 6 | CMC | 80 | 2 | 0.025 | 75 | 40 | 1.88 | 2456 |
| Embodiment 1-5 | | | | | | | | | | | | |
| Comparative | 50 | 90 | 4 | 6 | CMC | 80 | 42 | 0.525 | 75 | 70 | 1.07 | 12572 |
| Embodiment 1-6 | | | | | | | | | | | | |
| Comparative | 38 | / | / | / | / | 3.5 | / | / | 55 | / | / | / |
| Embodiment 1-7 | | | | | | | | | | | | |
| Comparative | 65 | 90 | 4 | 6 | CMC | 80 | 10 | 0.125 | 75 | 55 | 1.36 | 32075 |
| Embodiment 1-8 | | | | | | | | | | | | |

| | | | Elongation-at- | Tensile strength | Number of | | | |
|---|---|---|---|---|---|---|---|---|
| | | | break of film of | of film of | CNTs in a | | | |
| | | | composite | composite | carbon | | | |
| | \|η1−η0\| | \|η₂−η₀\| | conductive | conductive | nanotube | Total number of | Capacity | Expansion |
| | (mPa · s) | (mPa · s) | adhesive (%) | adhesive (MPa) | bundle | homogenization passes | retention rate (%) | rate (%) |
| Embodiment 1-1 | 82 | 321 | 40 | 20 | 3 | 9 | 90 | 12.0 |
| Embodiment 1-2 | 246 | 783 | 6 | 45 | 4 | 9 | 83 | 12.8 |
| Embodiment 1-3 | 156 | 667 | 20 | 37 | 3 | 9 | 91 | 12.4 |
| Embodiment 1-4 | 26 | 246 | 68 | 10 | 2 | 9 | 85 | 11.9 |
| Embodiment 1-5 | 109 | 800 | 19 | 25 | 3 | 9 | 87 | 13.0 |
| Embodiment 1-6 | 58 | 284 | 44 | 18 | 2 | 9 | 87 | 12.0 |
| Embodiment 1-7 | 258 | 799 | 30 | 38 | 5 | 11 | 84 | 12.5 |
| Embodiment 1-8 | 62 | 301 | 43 | 19 | 2 | 12 | 88 | 11.9 |
| Embodiment 1-9 | 335 | 725 | 20 | 43 | 3 | 7 | 84 | 12.8 |
| Embodiment 1-10 | 90 | 348 | 40 | 20 | 3 | 9 | 86 | 11.9 |
| Embodiment 1-11 | 68 | 305 | 40 | 20 | 3 | 9 | 92 | 12.1 |
| Embodiment 1-12 | 267 | 789 | 30 | 25 | 5 | 7 | 85 | 12.5 |
| Embodiment 1-13 | 177 | 366 | 38 | 17 | 3 | 12 | 87 | 12.5 |
| Comparative | 116 | 450 | 42 | 22 | 3 | 14 | 80 | 15.8 |
| Embodiment 1-1 | | | | | | | | |
| Comparative | 526 | 900 | 37 | 15 | 4 | 9 | 65 | 15.7 |
| Embodiment 1-2 | | | | | | | | |
| Comparative | 1200 | 2530 | 3 | 80 | 8 | 9 | 79 | 15.2 |
| Embodiment 1-3 | | | | | | | | |
| Comparative | 456 | 1097 | 8 | 40 | 8 | 9 | 76 | 13.9 |
| Embodiment 1-4 | | | | | | | | |
| Comparative | 76 | 286 | 60 | 10 | 3 | 18 | 72 | 11.8 |
| Embodiment 1-5 | | | | | | | | |
| Comparative | 587 | 924 | 6 | 98 | 17 | 4 | 68 | 14.8 |
| Embodiment 1-6 | | | | | | | | |
| Comparative | / | / | / | / | 4 | / | 70 | 15.2 |
| Embodiment 1-7 | | | | | | | | |
| Comparative | 2112 | 3247 | 1 | 100 | 6 | 9 | 61 | 16.1 |
| Embodiment 1-8 | | | | | | | | |

Note:
“/” in Table 1 means absence of the relevant parameter or substance.

TABLE 2

| | | | | | | | Average | | | |
|---|---|---|---|---|---|---|---|---|---|---|
| | | | | | | | particle | | Atomic | |
| | | | | | | | diameter | | mass | |
| | | | | Mole | Mole of | pH of | of | | percentage | |
| | Non- | | | percentage | percentage | raw | polymer | Reduction | of polar | Swelling |
| | curvature | | | of first | second | material | raw | peak | functional | ratio of |
| | ratio N | Isocyanate | Polyhydroxy | structural | structural | of | material | intensity | groups X | polymer |
| | (%) | monomer | polymer | unit (%) | unit (%) | polymer | (nm) | Y₁/Y₀ | (%) | film (%) |
| Embodiment 1-1 | 91 | IPDI | PCDL | 50 | 50 | 7.5 | 180 | 1.001 | 25 | 38 |
| Embodiment 2-1 | 93 | Diphenylmethane | PCDL | 50 | 50 | 7.8 | 250 | 1.005 | 20 | 40 |
| | | diisocyanate | | | | | | | | |
| Embodiment 2-2 | 90 | IPDI | Polyethylene | 50 | 50 | 7.8 | 200 | 1.003 | 20 | 42 |
| | | | carbonate | | | | | | | |
| | | | diol | | | | | | | |
| Embodiment 2-3 | 82 | IPDI | PCDL | 45 | 55 | 7.0 | 180 | 1.004 | 18 | 44 |
| Embodiment 2-4 | 93 | IPDI | PCDL | 55 | 45 | 8.0 | 180 | 1.003 | 28 | 26 |
| Embodiment 2-5 | 89 | IPDI | PCDL | 50 | 50 | 7.0 | 200 | 1.001 | 30 | 40 |
| Embodiment 2-6 | 92 | IPDI | PCDL | 50 | 50 | 8.5 | 165 | 1.001 | 23 | 35 |
| Embodiment 2-7 | 92 | IPDI | PCDL | 50 | 50 | 7.5 | 50 | 1.001 | 26 | 50 |
| Embodiment 2-8 | 95 | IPDI | PCDL | 50 | 50 | 7.5 | 80 | 1.001 | 29 | 45 |
| Embodiment 2-9 | 88 | IPDI | PCDL | 50 | 50 | 7.5 | 350 | 1.001 | 22 | 35 |
| Embodiment 2-10 | 80 | IPDI | PCDL | 50 | 50 | 7.5 | 400 | 1.001 | 21 | 25 |
| Embodiment 2-11 | 98 | IPDI | PCDL | 55 | 45 | 7.5 | 150 | 1.001 | 10 | 45 |
| Embodiment 2-12 | 99 | IPDI | PCDL | 45 | 55 | 8.5 | 120 | 1.001 | 5 | 45 |
| Embodiment 2-13 | 81 | IPDI | PCDL | 55 | 45 | 7.0 | 100 | 1.001 | 35 | 28 |
| Comparative | 79 | IPDI | PCDL | 60 | 40 | 7.0 | 120 | 1.001 | 35 | 20 |
| Embodiment 2-1 | | | | | | | | | | |
| Comparative | 70 | IPDI | PCDL | 40 | 60 | 8.5 | 80 | 1.02 | 5 | 48 |
| Embodiment 2-2 | | | | | | | | | | |

| | Viscosity of | | | Elongation-at- | Tensile strength | Number of | | |
|---|---|---|---|---|---|---|---|---|
| | composite | | | break of film of | of film of | CNTs in a | | |
| | conductive | | | composite | composite | carbon | Capacity | |
| | adhesive | \|η₁ − η₀\| | \|η₂ − n₀\| | conductive | conductive | nanotube | retention | Expansion |
| | (mPa · s) | (mPa · s) | (mPa · s) | adhesive (%) | adhesive (MPa) | bundle | rate (%) | rate (%) |
| Embodiment 1-1 | 3572 | 82 | 321 | 40 | 20 | 3 | 90 | 12.0 |
| Embodiment 2-1 | 3744 | 105 | 385 | 41 | 19 | 3 | 89 | 11.9 |
| Embodiment 2-2 | 3154 | 98 | 409 | 38 | 22 | 3 | 91 | 12.2 |
| Embodiment 2-3 | 2285 | 27 | 123 | 58 | 24 | 4 | 84 | 12.1 |
| Embodiment 2-4 | 3873 | 125 | 455 | 45 | 17 | 3 | 88 | 12.5 |
| Embodiment 2-5 | 3824 | 100 | 482 | 42 | 18 | 3 | 88 | 11.9 |
| Embodiment 2-6 | 3285 | 59 | 308 | 37 | 22 | 3 | 91 | 12.2 |
| Embodiment 2-7 | 1875 | 225 | 630 | 85 | 7 | 2 | 84 | 13.7 |
| Embodiment 2-8 | 2257 | 182 | 582 | 80 | 10 | 2 | 92 | 13.5 |
| Embodiment 2-9 | 4128 | 247 | 600 | 5 | 45 | 4 | 85 | 12.5 |
| Embodiment 2-10 | 5217 | 287 | 792 | 3 | 55 | 6 | 82 | 13.5 |
| Embodiment 2-11 | 2458 | 124 | 328 | 75 | 10 | 2 | 92 | 13.5 |
| Embodiment 2-12 | 1275 | 25 | 115 | 85 | 6 | 2 | 91 | 14.5 |
| Embodiment 2-13 | 4263 | 188 | 487 | 22 | 35 | 3 | 84 | 12.8 |
| Comparative | 4584 | 255 | 556 | 20 | 40 | 4 | 82 | 14.8 |
| Embodiment 2-1 | | | | | | | | |
| Comparative | 2154 | 14 | 257 | 35 | 25 | 5 | 78 | 15.1 |
| Embodiment 2-2 | | | | | | | | |

Referring to Table 1 and Table 2, as can be seen from Embodiments 1-1 to 1-13, Embodiments 2-1 to 2-13, Comparative Embodiments 1-1 to 1-8, and Comparative Embodiments 2-1 to 2-2, by using the composite conductive adhesive of this application, and by controlling the value of the length L_{c} and the non-curvature ratio N of the carbon nanotubes in the composite conductive adhesive to fall within the ranges specified herein, the viscosity of the composite conductive adhesive is relatively high, the values of |η₁−η₀| and |η₂−η₀| are relatively small, the elongation-at-break and the tensile strength of the film of the composite conductive adhesive are appropriate, and the measured number of carbon nanotubes in a carbon nanotube bundle of the film is relatively small, indicating that the composite conductive adhesive is of high stability, the carbon nanotubes in the composite conductive adhesive are highly dispersible, and the film of the composite conductive adhesive possesses superior mechanical properties. A lithium-ion battery prepared using the composite conductive adhesive of this application exhibits a relatively high capacity retention rate and a relatively low expansion rate, indicating that the lithium-ion battery achieves superior cycling performance and cycling expansion performance. By contrast, in Comparative Embodiments 1-1, 1-2, and 1-8, the polymers in the composite conductive adhesive fall outside the range specified herein. In the lithium-ion batteries of Comparative Embodiments 1-3 to 1-6 and Comparative Embodiments 2-1 to 2-2, at least one of L_{c} or N falls outside the range specified herein. In Comparative Embodiment 1-7, no composite conductive adhesive is employed. The lithium-ion batteries in the above comparative embodiments exhibit a relatively low capacity retention rate and a relatively high expansion rate, indicating that the cycling performance and cycling expansion performance of the lithium-ion batteries are inferior.

The composition of the composite conductive adhesive typically affects the cycling performance and cycling expansion performance of the lithium-ion battery. As can be seen from Embodiments 1-1 to 1-4, when the mass percentage of the polymer, the carbon nanotubes, and the dispersant is controlled to fall within the ranges specified herein, the lithium-ion battery is enabled to exhibit a relatively high capacity retention rate and a relatively low expansion rate, indicating that the lithium-ion battery achieves superior cycling performance and cycling expansion performance.

The type of the dispersant typically affects the cycling performance and cycling expansion performance of the lithium-ion battery. As can be seen from Embodiment 1-1 and Embodiment 1-5, when the dispersant falling within the range specified herein is applied, the lithium-ion battery is enabled to exhibit a relatively high capacity retention rate and a relatively low expansion rate, indicating that the lithium-ion battery achieves superior cycling performance and cycling expansion performance.

The length L_{c} of the carbon nanotube in the composite conductive adhesive typically affects the cycling performance and cycling expansion performance of the lithium-ion battery. As can be seen in Embodiment 1-1, Embodiments 1-5 to 1-9, and Comparative Embodiments 1-5 and 1-6, when the value of L_{c} is excessively small, such as in Comparative Embodiment 1-5, the lithium-ion battery exhibits a relatively low capacity retention rate. The applicant hereof speculates that because the carbon nanotubes in the composite conductive adhesive of Comparative Embodiment 1-5 are excessively short, although the carbon nanotubes are relatively easy to disperse and consequently exhibit a relatively high non-curvature ratio, the excessively short carbon nanotubes are not conducive to the formation of a conductive network in the negative electrode material layer, thereby hindering the improvement in the conductivity of the negative electrode material layer and consequently leading to inferior cycling performance of the lithium-ion battery. When the value of L_{c} is excessively large, such as in Comparative Embodiment 1-6, the lithium-ion battery exhibits a relatively low capacity retention rate and a relatively high expansion rate. As can be seen, the non-curvature ratio in Comparative Embodiment 1-6 is excessively small, indicating inferior dispersion of carbon nanotubes in the composite conductive adhesive, thereby being not conducive to exerting the function of the composite conductive adhesive, and failing to improve the cycling performance and cycling expansion performance of the lithium-ion battery. Therefore, when the value of L_{c} is controlled to fall within the range specified herein, the lithium-ion battery is enabled to exhibit a relatively high capacity retention rate and a relatively low expansion rate, indicating that the lithium-ion battery achieves superior cycling performance and cycling expansion performance.

The values of L_{c}/L₀, I₀, I₁, and I₀/I₁ typically affect the cycling performance and cycling expansion performance of the lithium-ion battery. As can be seen from Embodiment 1-1 and Embodiments 1-5 to 1-11, when the above parameters are controlled to fall within the ranges specified herein, the lithium-ion battery is enabled to exhibit a relatively high capacity retention rate and a relatively low expansion rate, indicating that the lithium-ion battery achieves superior cycling performance and cycling expansion performance.

The total number of homogenization passes typically affects the cycling performance and cycling expansion performance of the lithium-ion battery. As can be seen from Embodiment 1-1 and Embodiments 1-12 to 1-13, when the total number of homogenization passes is controlled to fall within the range specified herein, the carbon nanotubes in the composite conductive adhesive are enabled to possess an appropriate length, and the lithium-ion battery is enabled to exhibit a relatively high capacity retention rate and a relatively low expansion rate, indicating that the lithium-ion battery achieves superior cycling performance and cycling expansion performance.

The types of the isocyanate monomer and the polyhydroxy polymer typically affect the cycling performance and cycling expansion performance of the lithium-ion battery. As can be seen from Embodiment 1-1 and Embodiments 2-1 to 2-2, when the isocyanate monomer and the polyhydroxy polymer falling within the ranges specified herein are applied, the lithium-ion battery is enabled to exhibit a relatively high capacity retention rate and a relatively low expansion rate, indicating that the lithium-ion battery achieves superior cycling performance and cycling expansion performance.

The mole percentage of the isocyanate monomer and the polyhydroxy polymer typically affects the cycling performance and cycling expansion performance of the lithium-ion battery. As can be seen from Embodiment 1-1 and Embodiments 2-3 to 2-4, when the mole percentage of the isocyanate monomer and the polyhydroxy polymer is controlled to fall within the range specified herein, the carbon nanotubes in the composite conductive adhesive are enabled to possess an appropriate length, and the lithium-ion battery is enabled to exhibit a relatively high capacity retention rate and a relatively low expansion rate, indicating that the lithium-ion battery achieves superior cycling performance and cycling expansion performance.

The pH value of the raw material of the polymer typically affects the cycling performance and cycling expansion performance of the lithium-ion battery. As can be seen from Embodiment 1-1 and Embodiments 2-3 to 2-6, when the pH value of the raw material of the polymer is controlled to fall within the range specified herein, the lithium-ion battery is enabled to exhibit a relatively high capacity retention rate and a relatively low expansion rate, indicating that the lithium-ion battery achieves superior cycling performance and cycling expansion performance.

The particle diameter of the raw material of the polymer typically affects the cycling performance and cycling expansion performance of the lithium-ion battery. As can be seen from Embodiment 1-1 and Embodiments 2-7 to 2-10, when the particle diameter of the raw material of the polymer is controlled to fall within the range specified herein, the lithium-ion battery is enabled to exhibit a relatively high capacity retention rate and a relatively low expansion rate, indicating that the lithium-ion battery achieves superior cycling performance and cycling expansion performance.

The polar functional groups in the polyurethane in the embodiments or comparative embodiments in Table 1 and Table 2 include hydroxyl, amino, and urethane groups. The percentage of the total atomic mass of the polar functional groups relative to the weight-average molecular weight of the polymer is X. The value of X typically affects the cycling performance and cycling expansion performance of the lithium-ion battery. As can be seen from Embodiment 1-1 and Embodiments 2-1 to 2-13, when the value of X is controlled to fall within the range specified herein, the lithium-ion battery is enabled to exhibit a relatively high capacity retention rate and a relatively low expansion rate, indicating that the lithium-ion battery achieves superior cycling performance and cycling expansion performance.

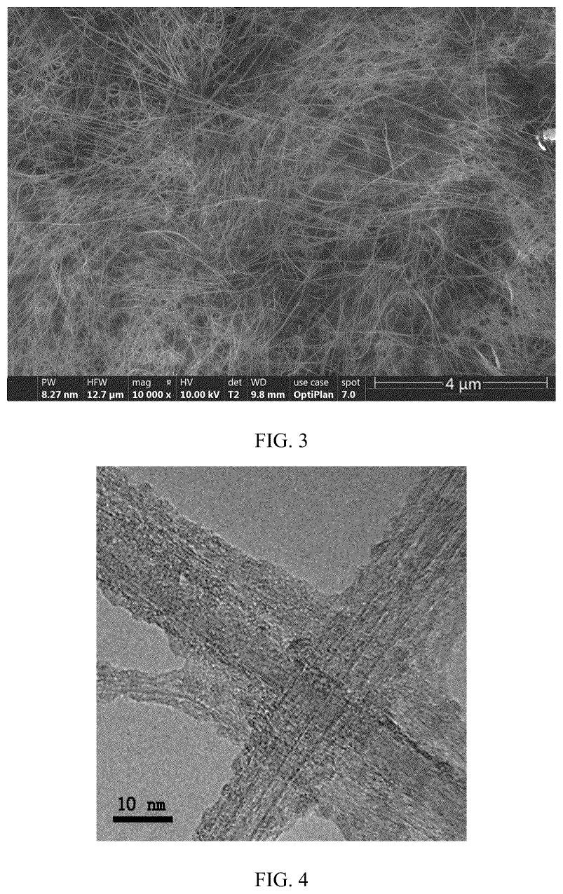

FIG. 2 is a scanning electron microscope image of a film prepared from a composite conductive adhesive according to Embodiment 1-1. As can be seen from FIG. 2, the carbon nanotubes are arranged in an array. Each carbon nanotube is distinct, with a low degree of bending and entanglement. FIG. 3 is a scanning electron microscope image of a film prepared from a composite conductive adhesive according to Comparative Embodiment 1-1. As can be seen from FIG. 3, the carbon nanotubes are bent and entangled to a high degree, indicating that the carbon nanotubes in the composite conductive adhesive of this application are more dispersed.

FIG. 4 is a transmission electron microscope image of a composite conductive adhesive according to Embodiment 1-1. As can be seen from FIG. 4, the carbon nanotubes are aggregated in the form of carbon nanotube bundles. The number of carbon nanotubes in each carbon nanotube bundle is 3. The polymer forms a film layer on the surface of each carbon nanotube. An average thickness of the film layers is 6 nm. The diameter of a single carbon nanotube is 2 nm. This indicates that polyurethane can adhere well to the surface of carbon nanotubes, and the carbon nanotubes are uniformly dispersed.

TABLE 3

| | | | Capacity retention | Expansion |
|---|---|---|---|---|
| | M (%) | Q (%) | rate (%) | rate (%) |
| Embodiment 1-1 | 20 | 5 | 90 | 12 |
| Embodiment 3-1 | 10 | 1.2 | 95 | 10.5 |
| Embodiment 3-2 | 15 | 3 | 92 | 11.6 |
| Embodiment 3-3 | 40 | 10 | 88 | 12.5 |
| Embodiment 3-4 | 60 | 11.5 | 85 | 12.8 |
| Embodiment 3-5 | 20 | 3 | 88 | 13.5 |
| Embodiment 3-6 | 20 | 10 | 87 | 11.8 |
| Embodiment 3-7 | 20 | 11.5 | 85 | 12.1 |
| Embodiment 3-8 | 20 | 13 | 78 | 13.1 |

The mass percentage M % of silicon typically affects the cycling performance and cycling expansion performance of lithium-ion batteries. As can be seen from Embodiment 1-1 and Embodiments 3-1 to 3-4, when the value of M is controlled to fall within the range specified herein, the lithium-ion battery is enabled to exhibit a relatively high capacity retention rate and a relatively low expansion rate, indicating that the lithium-ion battery achieves superior cycling performance and cycling expansion performance.

The mass percentage Q % of the binder typically affects the cycling performance and cycling expansion performance of the lithium-ion battery. As can be seen from Embodiment 1-1 and Embodiments 3-1 to 3-8, when the value of Q is controlled to fall within the range specified herein, the lithium-ion battery is enabled to exhibit a relatively high capacity retention rate and a relatively low expansion rate, indicating that the lithium-ion battery achieves superior cycling performance and cycling expansion performance.

It is noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

The terms such as “one of”, “one selected from”, “one thereof” and other similar terms preceding a list of items are intended to mean any one of the listed items. For example, “one of A or B” means A alone or B alone. As another example, “one of A, B, or C” means A alone, B alone, or C alone. The terms such as “at least one of”, “at least one selected from”, “at least one thereof” and other similar terms preceding a list of items are intended to mean any combination of the listed items. For example, “at least one of A or B” means A alone, B alone, or both A and B. As another example, “at least one of A, B, or C” means A alone, B alone, C alone, just A and B, just A and C, just B and C, or all of A, B, and C.

Different embodiments of this application are described in a correlative manner. For the same or similar part in one embodiment, reference may be made to another embodiment. Each embodiment focuses on differences from other embodiments.

The embodiments described above are merely preferred embodiments of this application, but are not intended to limit this application. Any and all modifications, equivalent replacements, improvements, and the like made without departing from the concept and principles of this application still fall within the protection scope of this application.

What is claimed is:

1. A composite conductive adhesive, comprising a polymer, carbon nanotubes, and a dispersant; wherein the polymer is polyurethane, an average length of the carbon nanotube in the composite conductive adhesive is L_{c} μm, and 5≤L_{c}≤20; and a non-curvature ratio of the carbon nanotubes is
$$N = \frac{{N}_{1}}{{N}_{1} + {N}_{2}} ,$$
and N≥80%,
wherein, N₁ is a number of carbon nanotubes with θ₀ less than or equal to 5°, N₂ is a number of carbon nanotubes with θ₀ greater than 5°, and θ₀ is an angle between a straight line L₁ and a tangent line L₂; in a scanning electron microscope image of a film of the composite conductive adhesive, a straight line connecting two ends of the carbon nanotube is defined as the straight line L₁; an endpoint with a larger curvature of the carbon nanotube is defined as a head of the carbon nanotube, and a tangent line that is tangent to the carbon nanotube at the head is defined as the tangent line L₂.

2. The composite conductive adhesive according to claim 1, wherein, based on a mass of the composite conductive adhesive, a mass percentage of the polymer is 70% to 99.8%, a mass percentage of the carbon nanotubes is 0.1% to 12%, and a mass percentage of the dispersant is 0.1% to 18%.

3. The composite conductive adhesive according to claim 1, wherein the polymer comprises a first structural unit of the polymer and a second structural unit of the polymer; the first structural unit of the polymer is an isocyanate monomer and the second structural unit of the polymer is a polyhydroxy polymer; the isocyanate monomer comprises at least one of diphenylmethane diisocyanate, toluene diisocyanate, or isophorone diisocyanate; and the polyhydroxy polymer comprises at least one of polycarbonate diol, polypropylene carbonate diol, or polyethylene carbonate diol; and
based on a sum of mole numbers of the first structural unit and the second structural unit, a mole percentage of the first structural unit is 45% to 55%, and a mole percentage of the second structural unit is 45% to 55%.

4. The composite conductive adhesive according to claim 1, satisfies at least one of the following characteristics:
(1) a pH value of a raw material of the polymer is 7 to 8.5;
(2) in a raw material of the polymer, the polymer is emulsion particles, and an average particle diameter of the emulsion particles is 80 nm to 350 nm;
(3) in a reduction curve of the polymer measured by cyclic voltammetry, a reduction peak appears at a voltage of 3 V to 0 V, a peak intensity of the reduction peak is Y₁, and a baseline intensity is Y₀, and 1≤Y₁/Y₀≤1.01;
(4) the polymer comprises polar functional groups; the polar functional groups comprise a urethane group, an amino group, a hydroxyl group, and a cyano group; and a percentage of a total atomic mass of the polar functional groups relative to a weight-average molecular weight of the polymer is X, and 10%≤X≤30%;
(5) a swelling ratio of the polymer is 25% to 45%; or
(6) 82%≤N≤98%.

5. The composite conductive adhesive according to claim 1, wherein an average length of carbon nanotubes in a powder raw material of the carbon nanotubes is L_{c} μm, and 0.05≤L_{c}/L₀≤0.5.

6. The composite conductive adhesive according to claim 1, wherein, in a Raman spectrum of a raw material of the carbon nanotubes, a G peak appears at 1525 cm⁻¹ to 1625 cm⁻¹, a D peak appears at 1300 cm⁻¹ to 1400 cm⁻¹, an intensity of the G peak is I_{G}, and an intensity of the D peak is I_{D}, I₀=I_{G}/I_{D}, and 60≤I₀≤80.

7. The composite conductive adhesive according to claim 6, wherein, in a Raman spectrum of the composite conductive adhesive, a G′ peak appears at 1525 cm⁻¹ to 1625 cm⁻¹, a D′ peak appears at 1300 cm⁻¹ to 1400 cm⁻¹, an intensity of the G′ peak is I_{G′}, and an intensity of the D′ peak is I_{D′}, I₁=I_{G′}/I_{D′}, 1.03≤I₀/I₁≤1.5, and I₁≥50.

8. The composite conductive adhesive according to claim 1, wherein the dispersant comprises at least one of polypropylene, cellulose, carboxymethyl cellulose, or lignin.

9. The composite conductive adhesive according to claim 1, satisfies at least one of the following characteristics:
(1) when a mass percentage of the composite conductive adhesive in an aqueous dispersion of the composite conductive adhesive stirred at a temperature of 25 °C and a speed of 12 rpm is 8.0% to 10.0%, a viscosity of the aqueous dispersion of the composite conductive adhesive ranges from 1000 mPa·s to 5000 mPa·s;
(2) a mass percentage of the composite conductive adhesive in an aqueous dispersion of the composite conductive adhesive is 8% to 10%, and a viscosity of the aqueous dispersion of the composite conductive adhesive is measured when the aqueous dispersion of the composite conductive adhesive is stored, an initial viscosity is η₀ mPa·s, the viscosity measured at a 7^{th} day is η₁ mPa·s, and the viscosity measured at a 28^{th} day is η₂ mPa·s, and |η₁−η₀|≤500, and |η₂−η₀|≤800;
(3) an elongation-at-break of the film of the composite conductive adhesive is 5% to 80%; or
(4) tensile strength of the film of the composite conductive adhesive is 10 MPa to 45 MPa.

10. The composite conductive adhesive according to claim 1, wherein, when the composite conductive adhesive is dispersed in water to obtain a dilution with a solid content of 0.01 wt %; in a transmission electron microscope image at 100,000× magnification, the carbon nanotubes in the dilution are aggregated in the form of carbon nanotube bundles; a number of carbon nanotubes in each carbon nanotube bundle is 2 to 6; the polymer forms a film layer on a surface of each carbon nanotube; an average thickness of the film layers is 2 to 4 times a diameter of a single carbon nanotube; and the diameter of the single carbon nanotube is 1.5 nm to 3.5 nm.

11. A method for preparing the composite conductive adhesive according to claim 1, the method comprising following steps: performing an emulsification and shearing process and a homogenization process on the polymer, the carbon nanotubes, the dispersant, and water; wherein a rotational speed in the emulsification and shearing process is 6,000 rpm to 12,000 rpm; and in the homogenization process, a total number of homogenization passes is 7 to 12 and a homogenization pressure is 10 MPa to 20 MPa.

12. The method according to claim 11, wherein an average length of the carbon nanotubes in a powder raw material of the carbon nanotubes is L_{c} μm, and 0.05≤L_{c}/L₀≤0.5.

13. The method according to claim 11, wherein, in a Raman spectrum of a raw material of the carbon nanotubes, a G peak appears at 1525 cm⁻¹ to 1625 cm⁻¹, a D peak appears at 1300 cm⁻¹ to 1400 cm⁻¹, an intensity of the G peak is I_{G}, and an intensity of the D peak is I_{D}, I₀=I_{G}/I_{D}, and 60≤I₀≤80.

14. A secondary battery, comprising a positive electrode plate and a negative electrode plate, wherein the negative electrode plate comprises a negative current collector and a negative electrode material layer disposed on at least one surface of the negative current collector, and the negative electrode material layer comprises the composite conductive adhesive according to claim 1.

15. The secondary battery according to claim 14, wherein the negative electrode material layer further comprises a silicon-containing material; the silicon-containing material comprises at least one of silicon, a silicon-carbon compound, or a silicon-oxygen compound; and
based on a mass of the negative electrode material layer, a mass percentage of silicon in the negative electrode material layer is M %, and 10≤M≤60.

16. The secondary battery according to claim 14, wherein, based on a mass of the negative electrode material layer, a mass percentage of the composite conductive adhesive is Q %, and 1.2≤Q≤11.5.

17. The secondary battery according to claim 14, wherein, based on a mass of the composite conductive adhesive, a mass percentage of the polymer is 70% to 99.8%, a mass percentage of the carbon nanotubes is 0.1% to 12%, and a mass percentage of the dispersant is 0.1% to 18%.

18. The secondary battery according to claim 14, satisfies at least one of the following characteristics:
(1) a pH value of a raw material of the polymer is 7 to 8.5;
(2) in a raw material of the polymer, the polymer is emulsion particles, and an average particle diameter of the emulsion particles is 80 nm to 350 nm;
(3) in a reduction curve of the polymer measured by cyclic voltammetry, a reduction peak appears at a voltage of 3 V to 0 V, a peak intensity of the reduction peak is Y₁, and a baseline intensity is Y₀, and 1≤Y₁/Y₀≤1.01;
(4) the polymer comprises polar functional groups, the polar functional groups comprise a urethane group, an amino group, a hydroxyl group, and a cyano group, and a percentage of a total atomic mass of the polar functional groups relative to a weight-average molecular weight of the polymer is X, and 10%≤X≤30%;
(5) a swelling ratio of the polymer is 25% to 45%; or
(6) 82%≤N≤98%.

19. The secondary battery according to claim 14, wherein the dispersant comprises at least one of polypropylene, cellulose, carboxymethyl cellulose, or lignin.

20. The secondary battery according to claim 14, satisfies at least one of the following characteristics:
(1) when a mass percentage of the composite conductive adhesive in an aqueous dispersion of the composite conductive adhesive stirred at a temperature of 25 °C and a speed of 12 rpm is 8.0% to 10.0%, a viscosity of the aqueous dispersion of the composite conductive adhesive ranges from 1000 mPa·s to 5000 mPa·s;
(2) a mass percentage of the composite conductive adhesive in an aqueous dispersion of the composite conductive adhesive is 8% to 10%, and a viscosity of the aqueous dispersion of the composite conductive adhesive is measured when the aqueous dispersion of the composite conductive adhesive is stored, an initial viscosity is η₀ mPa·s, the viscosity measured at a 7^{th} day is η₁ mPa·s, and the viscosity measured at a 28^{th} day is η₂ mPa·s, and |η₁−η₀|≤500, and |η₂−η₀|≤800;
(3) an elongation-at-break of the film of the composite conductive adhesive is 5% to 80%; or
(4) tensile strength of the film of the composite conductive adhesive is 10 MPa to 45 MPa.
